(19) United States
(12) Patent Application Publication
(10) Pub. No.: US 2020/0065735 A1
(43) Pub. Date: Feb. 27, 2020

(54) SUPPLY CHAIN OPERATIONS PROCESS OPTIMIZATION DEVICE AND SUPPLY CHAIN OPERATIONS SUPPORTING METHOD

(71) Applicant: HITACHI, LTD., Tokyo (JP)

(72) Inventors: Ayaka YAMAGUCHI, Tokyo (JP); Ryoji FURUHASHI, Tokyo (JP); Yuichi TAKAHASHI, Tokyo (JP); Tazu NOMOTO, Tokyo (JP)

(73) Assignee: HITACHI, LTD., Tokyo (JP)

(21) Appl. No.: 16/295,828

(22) Filed: Mar. 7, 2019

(30) Foreign Application Priority Data
Aug. 23, 2018 (JP) 2018-156257

(51) Int. Cl. G06Q 10/06

(52) U.S. Cl. CPC G06Q 10/06315; G06Q 10/067; G06Q 10/06312

(57) ABSTRACT

According to one embodiment, a scheduling unit determines a derivation start date and time and derivation end date and time for each supply chain model on the basis of a time required for deriving a restriction relaxing optimum operations combination and a relaxation proposing timing, a schedule execution unit starts deriving a restriction relaxing optimum operations combination for a target supply chain model on the basis of the derivation start date and time determined by the scheduling unit, and a restriction relaxing optimum operations combination-generating unit generates an operations combination of update timings and methods for plans or instructions assuming that a restriction is relaxed.

### CROSS-REFERENCE TO RELATED APPLICATIONS

This application is based upon and claims the benefit of priority from Japanese Patent Application No. 2018-156257, filed on Aug. 23, 2018; the entire contents of all of which are incorporated herein by reference.

### FIELD

The present invention relates to derivation of supply chain operations process.

### BACKGROUND

The recent rapid advancement of globalization and increased competition has led to greater market movement. In the manufacturing industry, expectations for supply chain optimization has been increased for the purpose of achieving some objects such as inventory reduction, shorter lead time, and on-time delivery. The supply chain optimization requires reduction of a gap between a planned value and an actual value. For example, such a request can be fulfilled by calculating an optimum supply chain through simulation using actual values.

For increasing competitiveness in the manufacturing industry, it is not sufficient only to focus on product capability. Improvement of customer satisfaction such as short delivery time and ability to rapidly response to inquiries on delivery time, and enforcement of financial constitution through improvement of cashflow achieved by reduction of inventory has also been required. Furthermore, factory operations need to be modified, as appropriate, so as to achieve a high-mix low-volume production to respond to needs for diversification in preferences of customers and so as to respond to a shorter product life cycle. Planning and execution of measures for fulfilling these demands have been performed on the basis of the experience and intuition of workers, and thus appropriate measures have not been introduced in a stable manner.

WO 16/002278 discloses a technique of providing an idea of a more appropriate supply chain operations process satisfying operations restrictions on operations. WO 16/002278 discloses a technique of generating a restriction-satisfying optimum operations combination and a restriction-relaxing optimum operations combination to derive an operations combination with an increased evaluation KPI (Key Performance Indicator) or an increased relaxation effect index.

### SUMMARY

To design a more appropriate configuration of a supply chain operations process, frequent changes are required on timings and quantities of instructions for flows of products (such as parts or manufactured products) and cash from one location to another. For example, when the number of companies constituting a supply chain and the number of plans or instructions from companies constituting the supply chain increase, derivation of a more appropriate operations combination will be required before applying a restriction-relaxing optimum operations combination.

Meanwhile, the technique disclosed in WO 16/002278 is silent about the timing at which the restriction relaxing optimum operations combination is implemented. Furthermore, although WO 16/002278 indicates that “various generation methods may be employed for reducing the number of operations combinations to be generated”, WO 16/002278 is silent about a time required for deriving an optimum operations combination.

The present invention has been completed in view of the above state and provides a supply chain operations process optimization device and a supply chain operation supporting method with which a more appropriate operations combination for a supply chain can be proposed before the time at which the combination is required.

A supply chain operations process optimization device according to an aspect of the present invention includes a first operations combination-generating unit configured to derive an operations combination with a relaxed operations restriction on a supply chain and a scheduling unit configured to determine an operations combination derivation-starting timing with the relaxed operations restriction on the basis of a time required for deriving the operations combination with the relaxed operations restriction.

According to the present invention, a more appropriate operations combination for a supply chain can be proposed before the time at which the combination is required.

### BRIEF DESCRIPTION OF THE DRAWINGS

FIG. 1 is a block diagram illustrating an example of a configuration of a supply chain operations process optimizing system according to a first embodiment;

FIG. 2 is a block diagram illustrating an example of a configuration of a supply chain operations process optimization device according to the first embodiment illustrated in FIG. 1;

FIG. 3 is a diagram illustrating an example of a model name table stored in a supply chain model storage unit in FIG. 2;

FIG. 4 is a diagram illustrating an example of an inter-sector transaction condition parameter table stored in the supply chain model storage unit in FIG. 2;

FIG. 5 is a diagram illustrating an example of a production condition parameter table stored in the supply chain model storage unit in FIG. 2;

FIG. 6 is a diagram illustrating an example of a plan or instruction operation parameter table stored in the supply chain model storage unit in FIG. 2;

FIG. 7 is a diagram illustrating an example of an update timing restriction table stored in an operations restriction storage unit in FIG. 2;

FIG. 8 is a diagram illustrating an example of an update method restriction table stored in the operations restriction storage unit in FIG. 2;

FIG. 9 is a diagram illustrating an example of a restriction change table stored in the operations restriction storage unit in FIG. 2;

FIG. 10 is a diagram illustrating an example of a priority table stored in an update timing storage unit in FIG. 2;

FIG. 11 is a diagram illustrating an example of a timing of proposal table stored in the update timing storage unit in FIG. 2;

FIG. 12 is a diagram illustrating an example of a satisfaction derivation operations combination table stored in an operations combination storage unit in FIG. 2;

FIG. 13 is a diagram illustrating an example of a relaxation derivation operations combination table stored in the operations combination storage unit in FIG. 2;

FIG. 14 is a diagram illustrating an example of a derivation time table stored in a derivation time storage unit in FIG. 2;

FIG. 15 is a diagram illustrating an example of a scheduling table stored in a scheduling storage unit in FIG. 2;

FIG. 16 is a diagram illustrating an example of an execution timing table stored in a scheduling storage unit in FIG. 2;

FIG. 17 is a flowchart illustrating an example of a supply chain model registration process;

FIG. 18 is a diagram illustrating an example of a supply chain model registration screen;

FIG. 19 is a flowchart illustrating an example of an operations restriction registration process;

FIG. 20 is a diagram illustrating an example of an operations restriction registration screen;

FIG. 21 is a flowchart illustrating an example of an update timing change process;

FIG. 22 is a diagram illustrating an example of an update timing change screen;

FIG. 23 is a flowchart illustrating an example of a restriction-satisfying optimum operations combination generation process;

FIG. 24 is a diagram illustrating an example of a restriction-satisfying optimum operations combination screen;

FIG. 25 is a flowchart illustrating an example of a scheduling process;

FIG. 26 is a flowchart illustrating an example of a schedule execution process;

FIG. 27 is a timing chart illustrating an example of a scheduling execution process performed by a schedule execution unit;

FIG. 28 is a flowchart illustrating an example of a restriction relaxing optimum operations combination generation process;

FIG. 29 is a diagram illustrating an example of a restriction relaxing optimum operations combination screen;

FIG. 30 is a diagram illustrating an example of a process sequence performed by the supply chain operations process optimization device in FIG. 2;

FIG. 31 is a flowchart illustrating an example of a supply chain model registration process according to a second embodiment;

FIG. 32 is a flowchart illustrating an example of a restriction-satisfying optimum operations combination generation process according to a second embodiment;

FIG. 33 is a flowchart illustrating an example of a scheduling execution process according to the second embodiment; and

FIG. 34 is a block diagram illustrating a hardware configuration example of the supply chain operations process optimization device illustrated in FIG. 1.

### DETAILED DESCRIPTION OF THE EMBODIMENT

Embodiments will now be described with reference to the accompanying drawings. Embodiments described below are not intended to limit the invention according to the scope of the claims, and not all of the components described in the embodiments and combinations thereof are essential to the means for solving the problem according to the present invention.

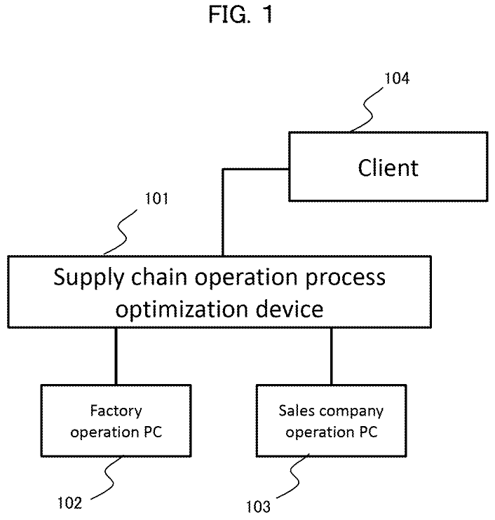

FIG. 1 is a block diagram illustrating a configuration of a supply chain operations process optimizing system according to a first embodiment.

In FIG. 1, the supply chain operations process optimizing system includes a supply chain operations process optimization device 101, a factory operation PC (Personal Computer) 102, a sales company operation PC 103, and a client 104. The supply chain operations process optimization device 101 is coupled to the factory operation PC 102, the sales company operation PC 103, and the client 104 through a network.

The supply chain operations process optimization device 101 proposes an operations combination with a higher evaluation KPI (Key Performance Indicator) before a set timing to a registered supply chain model. The supply chain model may include information about logistics and cashflow. A plurality of supply chain models may be registered.

Here, the supply chain operations process optimization device 101 can determine an operations combination derivation-starting timing with a relaxed operations restriction on the basis of a time required for deriving the operations combination with the relaxed operations restriction on the supply chain. The operations restriction can include restrictions related to an update timing and method for each plan or instruction each department constituting the supply chain.

The factory operation PC 102 holds information about an article and the like handled by each factory company. The information about an article and the like handled by each factory company can be input by a staff member of the factory company and the like. The sales company operation PC 103 holds information about an article and the like handled by each sales company. The information about an article and the like handled by each sales company can be input by a staff member of the sales company and the like.

The client 104 displays information about each company accumulated in the factory operation PC 102 and the sales company operation PC 103, extracted via the supply chain operations process optimization device 101, to a user in charge of improving the supply chain. The client 104 registers information required for the supply chain model as a target of optimization by the user, in the supply chain operations process optimization device 101.

As described above, the supply chain operations process optimization device 101 determines the operations combination derivation-starting timing with the relaxed operations restriction, on the basis of the time required for deriving the operations combination with the relaxed operations restriction on the supply chain. Thus, a supply chain operations combination with higher relaxation effect can be proposed before the time at which the combination is required even if there is a limited computing resource and/or even if the number of operations combinations of the supply chain increases.

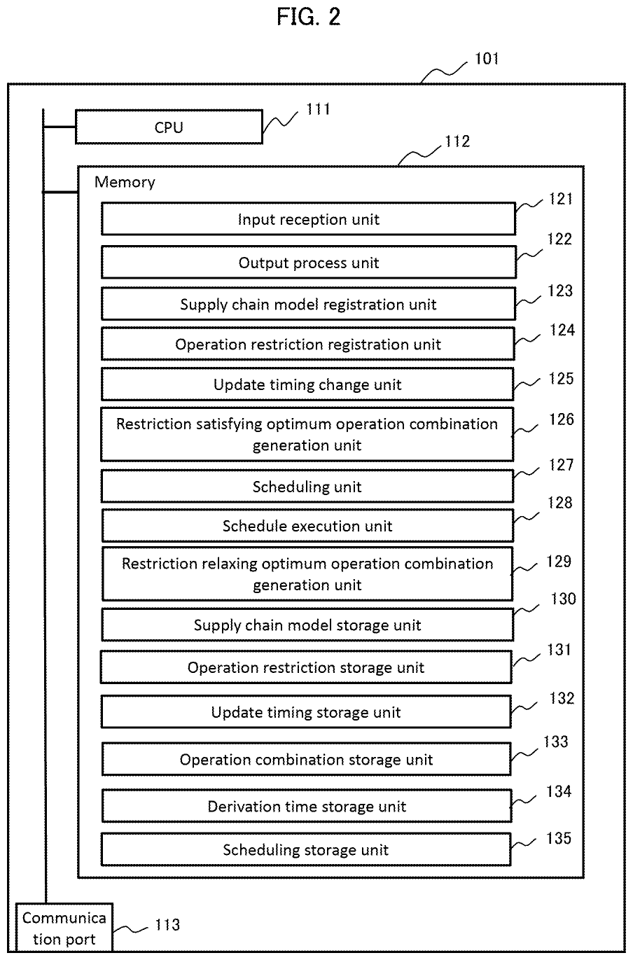

FIG. 2 is a block diagram illustrating a configuration of the supply chain operations process optimization device according to the first embodiment illustrated in FIG. 1.

In FIG. 2, the supply chain operations process optimization device 101 includes a Central-Processing-Unit (hereinafter, referred to as a CPU) 111, a memory 112, and a communication port 113. The CPU 111, the memory 112, and the communication port 113 are connected to each other. The communication port 113 can be used for communications with the factory operation PC 102, the sales company operation PC 103, and the client 104 in FIG. 1.

The memory 112 includes an input reception unit 121, an output process unit 122, a supply chain model registration unit 123, an operations restriction registration unit 124, an update timing change unit 125, a restriction-satisfying optimum operations combination-generating unit 126, a scheduling unit 127, a schedule execution unit 128, a restriction relaxing optimum operations combination-generating unit 129, a supply chain model storage unit 130, an operations restriction storage unit 131, an update timing storage unit 132, an operations combination storage unit 133, a derivation time storage unit 134, and a scheduling storage unit 135.

The input reception unit 121, the output process unit 122, the supply chain model registration unit 123, the operations restriction registration unit 124, the update timing change unit 125, the restriction-satisfying optimum operations combination-generating unit 126, the scheduling unit 127, the schedule execution unit 128, and the restriction relaxing optimum operations combination-generating unit 129 can be configured by a program that can be executed by the CPU 111.

The CPU 111 loads and executes a program stored in the memory 112, to implement the functions of the input reception unit 121, the output process unit 122, the supply chain model registration unit 123, the operations restriction registration unit 124, the update timing change unit 125, the restriction-satisfying optimum operations combination-generating unit 126, the scheduling unit 127, the schedule execution unit 128, and the restriction relaxing optimum operations combination-generating unit 129.

The input reception unit 121 receives an instruction and information input by the user through an input device of the client 104. For example, the input reception unit 121 receives information for an optimization target supply chain, input through the input device, related to flows of any one of operations, products, and cash, and/or information about a restriction on the update timing and method for each plan or instruction of each department. In accordance with the type of input information and/or instruction received, the input reception unit 121 transfers the information and/or instruction to a predetermined functional unit. The input reception unit 121 may not only receive an instruction input through the input device, but also receive an instruction input from an external device through a remote operation.

The output process unit 122 generates screen information to be displayed on an output device of the client 104. Specifically, the output process unit 122 generates screen information for configuring an input screen for receiving predetermined information input from the user, and screen information for configuring a display screen for information related to an optimum operations combination and displays these pieces of information on the output device. The output process unit 122 may transmit the screen information to an external device, to cause the external device to display predetermined screen information.

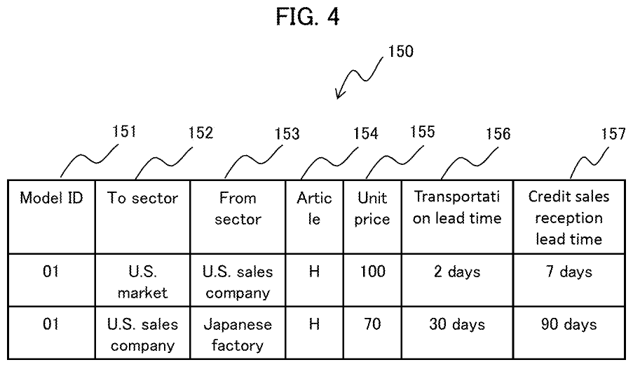

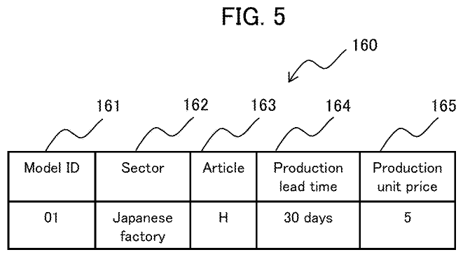

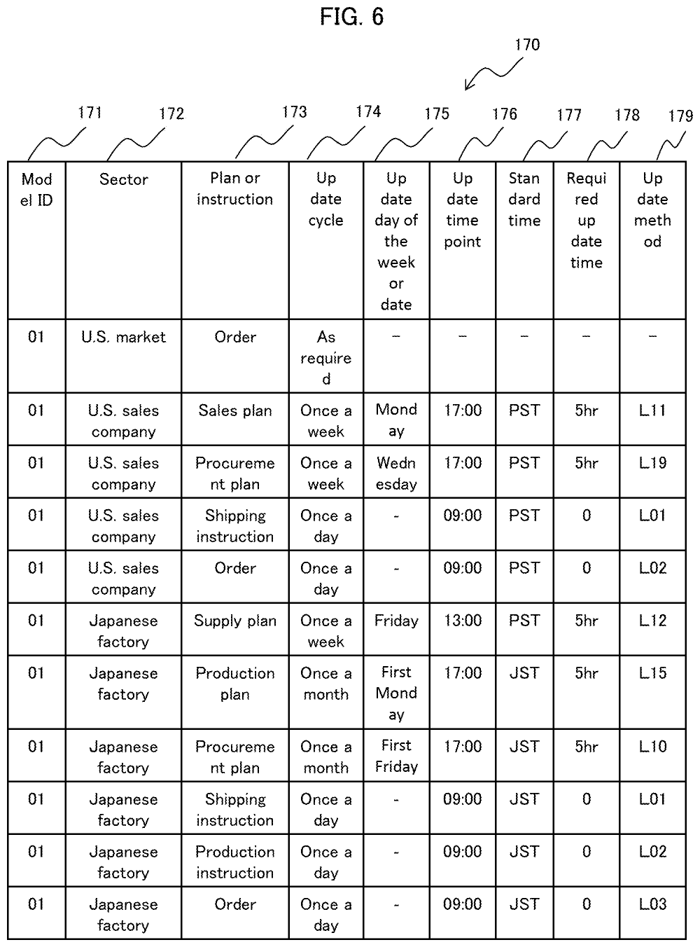

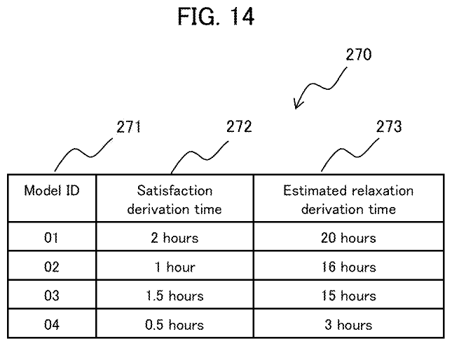

The supply chain model registration unit 123 acquires information related to flows of any one of operations, products, and cash, for a supply chain as an operations process optimization target, and registers these pieces of information as a supply chain model together with a supply chain model name. Specifically, the supply chain model registration unit 123 generates an inter-sector transaction condition parameter table 150 in FIG. 4, a production condition parameter table 160 in FIG. 5, and a plan or instruction operation parameter table 170 in FIG. 6 on the basis of the information related to flows of any one of operations, products, and cash, for the supply chain received from the client 104 through the input device, and stores the tables in the supply chain model storage unit 130. A derivation time table 270 in FIG. 14 may be generated through estimation of a time (referred to as a satisfaction derivation time) required for deriving the restriction-satisfying optimum operations combination on the basis of resource information about the CPU 111 and the like from the configuration of the supply chain model and stored in the derivation time storage unit 134.

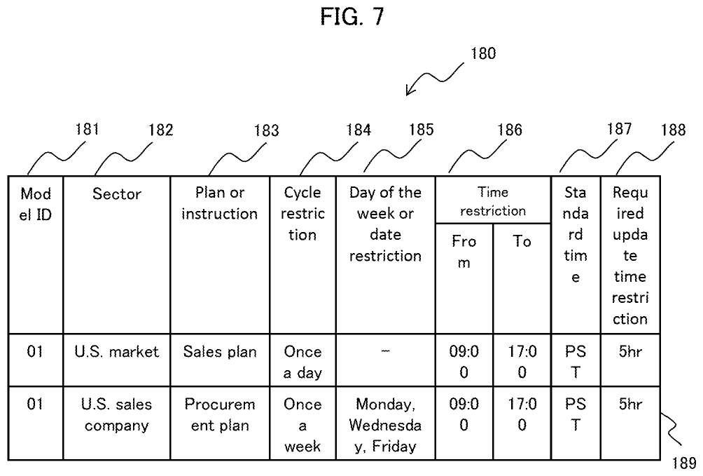

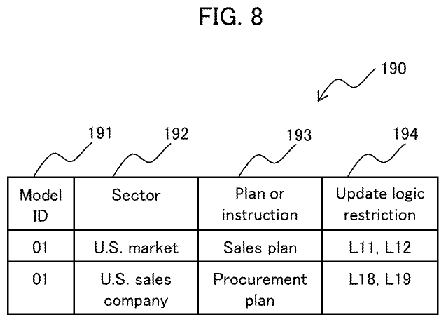

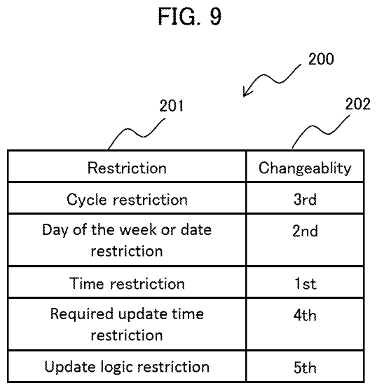

For the supply chain that is an operations process optimization target, the operations restriction registration unit 124 receives information about the restriction on the update timing and the method for each plan or instruction from each sector and registers these pieces of information as an operations restriction. The restriction on the update timing and the method for each plan or instruction from each sector includes a cycle restriction, a day of the week or date restriction, a time restriction, a required update time restriction, and an update logic restriction. The operations restriction registration unit 124 sets an order of changeability of these five restrictions. Specifically, the operations restriction registration unit 124 generates an update timing restriction table 180 in FIG. 7, an update method restriction table 190 in FIG. 8, and a restriction change table 200 in FIG. 9 on the basis of the information about the restriction on the update timing and the method for each plan or instruction from each sector received through the input device and stores the tables in the operations restriction storage unit 131.

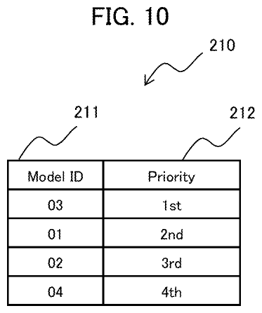

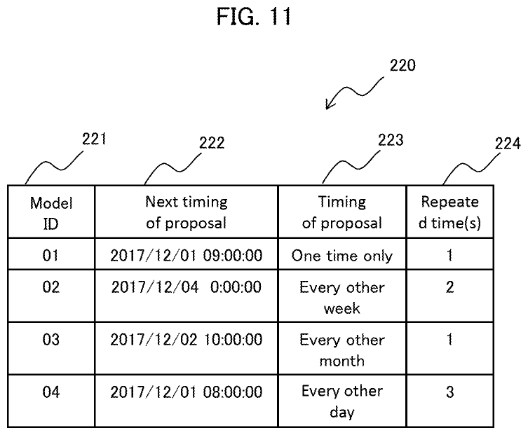

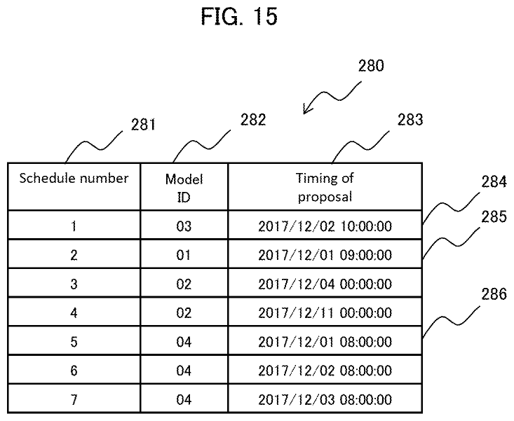

For the supply chain that is an operations process optimization target model, the update timing change unit 125 registers priorities for restriction relaxation and relaxation proposing timings of all the supply chain models that have been registered. The relaxation proposing timing is date and time when the restriction relaxing optimum operations combination is required. Specifically, the update timing change unit 125 generates a priority table 210 in FIG. 10 and a timing of proposal table 220 in FIG. 11 on the basis of the information related to the priority and the relaxation proposing timing received through the input device and stores these pieces of information in the update timing storage unit 132. Furthermore, a scheduling table 280 in FIG. 15 is generated on the basis of the priority table 210 and the timing of proposal table 220 generated and is stored in the scheduling storage unit 135.

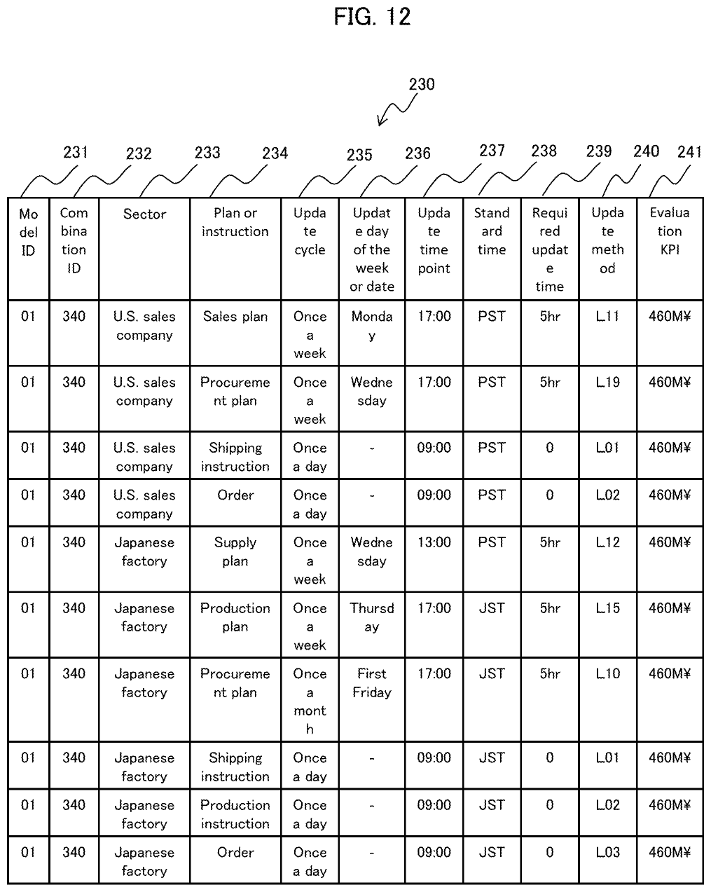

The restriction-satisfying optimum operations combination-generating unit 126 generates an operations combination of update timings and methods for each plan or instruction satisfying the operations restriction and calculates evaluation KPIs for all the operations combinations to derive the restriction-satisfying optimum operations combination. The restriction-satisfying optimum operations combination-generating unit 126 estimates a time (hereinafter, referred to as a relaxation derivation time) required for deriving the restriction relaxing optimum operations combination, on the basis of the satisfaction derivation time. Specifically, the restriction-satisfying optimum operations combination-generating unit 126 measures a time required for deriving the restriction-satisfying optimum operations combination from the operations combination generated, generates a derivation time table 270 in FIG. 14 on the basis of the measurement result, and stores the table in the derivation time storage unit 134. Furthermore, the restriction-satisfying optimum operations combination-generating unit 126 refers to the plan or instruction operation parameter table 170 stored in the supply chain model storage unit 130 as well as the update timing restriction table 180 and the update method restriction table 190 stored in the operations restriction storage unit 131 to generate a satisfaction derivation operations combination table 230 in FIG. 12, and stores the table in the operations combination storage unit 133.

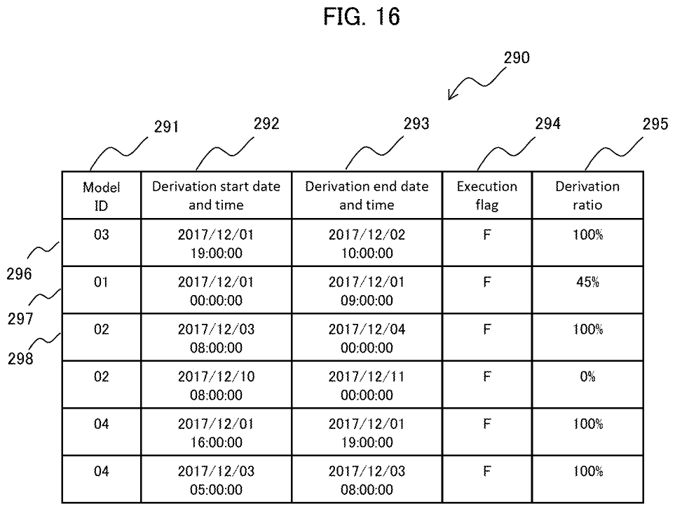

The scheduling unit 127 determines derivation start date and time and derivation end date and time for each supply chain model on the basis of the time required for deriving the restriction relaxing optimum operations combination and the relaxation proposing timing of each supply chain model. Specifically, the scheduling unit 127 generates an execution timing table 290 in FIG. 16 on the basis of the derivation time table 270 stored in the derivation time storage unit 134 and the scheduling table 280 stored in the scheduling storage unit 135 and stores the table in the scheduling storage unit 135.

The schedule execution unit 128 starts the derivation of the restriction relaxing optimum operations combination for a target supply chain model on the basis of the derivation start date and time determined by the scheduling unit 127 and identifies the supply chain model for which the derivation is being performed. The schedule execution unit 128 updates the execution timing table 290 stored in the scheduling storage unit 135.

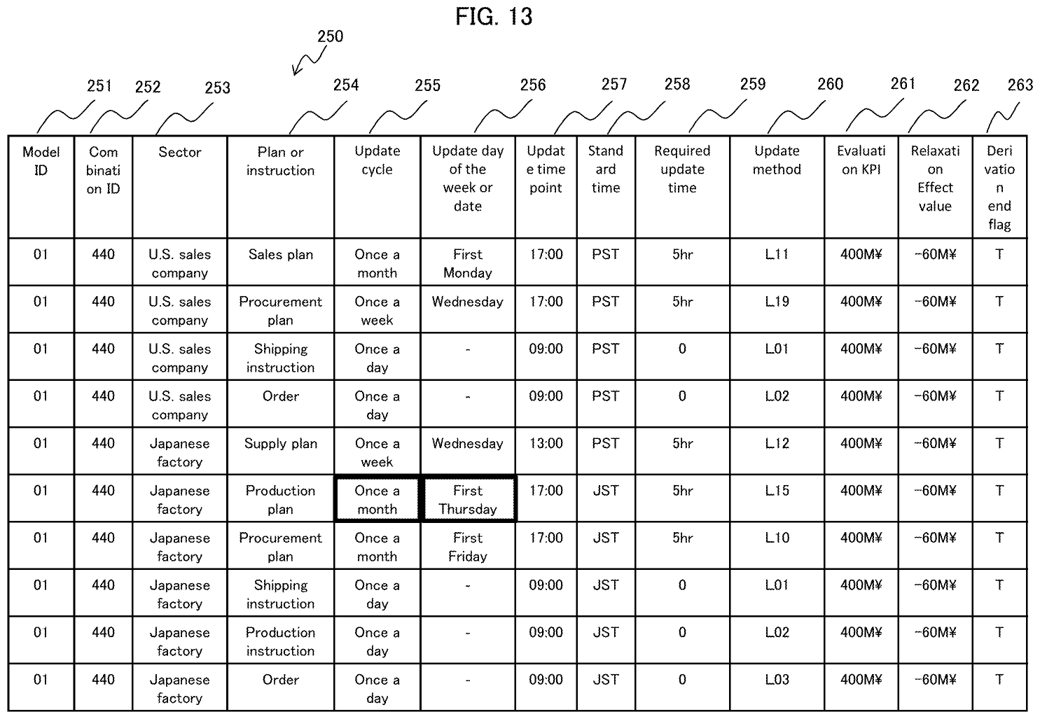

The restriction relaxing optimum operations combination-generating unit 129 generates an operations combination of an update timing and a method for each plan or instruction, to be obtained as a result of relaxation. The restriction relaxing optimum operations combination-generating unit 129 calculates an evaluation KPI (Key Performance Index) for each operations combination after the restriction is relaxed. The restriction relaxing optimum operations combination-generating unit 129 calculates a relaxation effect index indicating the effect of relaxing the restriction on the basis of the evaluation KPI of the operations combination before the restriction is relaxed and the evaluation KPI of the operations combination after the restriction is relaxed. The restriction relaxing optimum operations combination-generating unit 129 generates a relaxation derivation operations combination table 250 in FIG. 13 on the basis of the evaluation KPI and the relaxation effect value as well as the satisfaction derivation operations combination table 230 and stores the table in the operations combination storage unit 133.

The supply chain model storage unit 130 stores the supply chain model name and the information related to flows of any one of operations, products (such as parts or manufactured products), and cash. The operations restriction storage unit 131 stores information relates to restriction on the update timing and the method for each plan or instruction from each sector. The update timing storage unit 132 stores information related to priorities among a plurality of supply chain models and timings for relaxing the restriction. For each plan or instruction from each sector constituting the supply chain, the operations combination storage unit 133 stores all possible combinations of the update timings and methods. For each supply chain, the derivation time storage unit 134 stores the derivation time required for the restriction-satisfying optimum operations combination and for the restriction relaxing optimum operations combination. When deriving the restriction relaxing optimum operations combination for a plurality of supply chain models, the scheduling storage unit 135 stores information used for performing scheduling to prevent the derivation to result in a conflict in the supply chain operations process optimization devices 101.

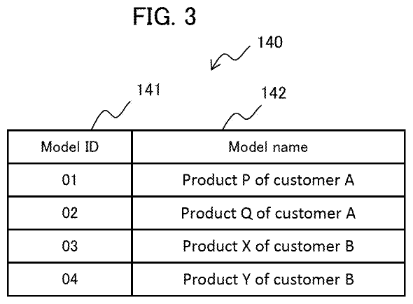

FIG. 3 is a diagram illustrating an example of a model name table stored in the supply chain model storage unit in FIG. 2.

In FIG. 3, the model name table 140 includes a record in which model ID 141 and model name 142 are associated with each other.

The model ID 141 is an identifier that uniquely identifies each of a plurality of supply chain models. The model name 142 is a supply chain model name (a product P of a customer A for example), input by the user for the model ID 141, through the client 104.

FIG. 4 is a diagram illustrating an example of an inter-sector transaction condition parameter table stored in the supply chain model storage unit in FIG. 2.

In FIG. 4, the inter-sector transaction condition parameter table 150 includes a record in which model ID 151, To sector 152, From sector 153, article 154, unit price 155, transportation lead time 156, and credit sales reception lead time 157 are associated with each other.

The model ID 151 is information that is similar to the item with the same name in the model name table 140 in FIG. 3. The To sector 152 is information for identifying a receiver of an article. Examples of the To sector 152 include a market (such as the U.S. market) or a sales company (such as a U.S. sales company). The From sector 153 is information identifying a shipping source of an article. Examples of the From sector 153 include a sales company (such as a U.S. sales company) and a factory (Japanese factory). The article 154 is information (a product name or a product code for example) for identifying an article (product) to be shipped or received. The unit price 155 is information for identifying a price of a trading unit of the article identified by the article 154. The transportation lead time 156 is information for identifying a period required for transportation for a traded article identified with the article 154. The credit sales reception lead time 157 is information for identifying a period between a point when the article identified with the article 154 is received by the receiver indicated with the To sector 152 and a point when the money is paid to the shipping source indicated by the From sector 153.

FIG. 5 is a diagram illustrating an example of a production condition parameter table stored in the supply chain model storage unit in FIG. 2.

In FIG. 5, the production condition parameter table 160 includes a record in which model ID 161, sector 162, article 163, production lead time 164, and production unit price 165 are associated with each other.

The model ID 161 is information similar to the item with the same name in the model name table 140 in FIG. 3. The sector 162 is information (such as a sector name for example) for identifying a sector that produces an article identified with the model ID 161 and the article 163. The article 163 is information for identifying an article to be produced. The production lead time 164 is information for identifying a period required for producing the article identified with the model ID 161 and the article 163. The production unit price 165 is information for identifying a cost other than a direct material cost required for producing a unit of the article identified with the model ID 161 and the article 163.

FIG. 6 is a diagram illustrating an example of a plan or instruction operation parameter table stored in the supply chain model storage unit in FIG. 2.

The plan or instruction operation parameter table 170 in FIG. 6 includes a record in which model ID 171, sector 172, plan or instruction 173, update cycle 174, update day of the week or date 175, update time point 176, standard time 177, required update time 178, and update method 179 are associated with each other.

The model ID 171 is information similar to the item with the same name in the model name table 140 in FIG. 3. The sector 172 is information (for example, a sector name) that identifies a sector that makes a plan or an instruction. The plan or instruction 173 is information for identifying the type of the plan or instruction to be made. Examples of the plan or instruction 173 include an order, a sales plan, a procurement plan, a shipping instruction, a supply plan, a production plan, and a production instruction. The update cycle 174 is information for identifying a cycle in which the plan or instruction is updated. Examples of the update cycle 174 include as required, once a day, once a week, once a month, once a season, and once in every quarter. The update day of the week or date 175 is information for identifying the day of the week or the date when the plan or instruction is updated. Examples of the update day of the week or date 175 include Monday, Tuesday, first Monday (Monday of the first week of each month), and first Friday (Friday of the first week of each month). The update time point 176 is information for identifying a time point at which the updating of the plan or instruction is completed. The standard time 177 is information for identifying standard time for the update time point. Examples of the standard time 177 include PST (PACIFIC-Standard-Time) and JST (Japan-Standard-Time). The required update time 178 is information for identifying a time required for updating the plan or instruction. The update method 179 is information for identifying an update method for the plan or instruction (for example, an update logic name). The update method 179 can be indicated with logics L01 and L02 and the like for example. The logics L01 and L02 and the like can be used for identifying a method for updating the update cycle 174, the update day of the week or date 175, and the like.

The inter-sector transaction condition parameter table 150 in FIG. 4, the production condition parameter table 160 in FIG. 5, and the plan or instruction operation parameter table 170 in FIG. 6 are used for generating the satisfaction derivation operations combination table 230 in FIG. 12.

FIG. 7 is a diagram illustrating an example of an update timing restriction table stored in the operations restriction storage unit in FIG. 2.

In FIG. 7, the update timing restriction table 180 includes a record in which model ID 181, sector 182, plan or instruction 183, cycle restriction 184, day of the week or date restriction 185, time restriction 186, standard time 187, and required update time restriction 188 are associated with each other.

The model ID 181, the sector 182, the plan or instruction 183, and the standard time 187 are pieces of information that are the same as items with the same names in the plan or instruction operation parameter table 170 in FIG. 6. The cycle restriction 184 is information for identifying a restriction on the update cycle for the plan or instruction. An example of the cycle restriction 184 in a record 189 includes “every week”. This indicates that the update cycle for the procurement plan in the U.S. sales company can be set to be “every month”, “every season”, and “every quarter” which are longer than “every week” but cannot be set to be “every day”, which is a shorter cycle than “every week”.

The day of the week or date restriction 185 is information for identifying a restriction on the day of the week on which the plan or instruction is updated. For example, the day of the week or date restriction 185 in the record 189 is “Monday, Wednesday, and Friday”. This indicates that the plan or the instruction, related to the procurement plan for the U.S. sales company, can be updated only on Monday, Wednesday, and Friday.

The time restriction 186 is information for identifying a restriction on a time in which a plan or instruction is updated. For example, this information in the record 189 indicates that the plan or instruction, related to the procurement plan for the U.S. sales company, can only be updated between 09:00 and 17:00.

The required update time restriction 188 is information for identifying a restriction on a time required for updating the plan or instruction. For example, this information in the record 189 indicates that the time required for updating the plan or instruction, related to the procurement plan for the U.S. sales company, cannot be set to be shorter than five hours.

The operations combination for a supply chain is generated on the basis of the content of restriction registered in the record 189. The record 189 has “U.S. sales company” registered in the sector 182 and has “procurement plan” registered in the plan or instruction 183. In the cycle restriction 184, “every week” is registered. In this case, the selection patterns for the operations combination of the update cycle 174 for the procurement plan of the U.S. sales company in FIG. 6 include “every week”, “every month”, “every season” and “every quarter”, which are lower frequency than every week. The selection patterns for the operations combination of the operations combination of the day of the week or date restriction 185 include “Monday”, “Wednesday”, and “Friday”.

In an example where the operations combination for a supply chain is generated only with such cycle restriction 184 and day of the week or date restriction 185, if the update cycle 174 is every week, the update day of the week or date 175 for this operations combination includes three selection patterns of Monday, Wednesday, and Friday. If the update cycle 174 is every month, the update day of the week or date 175 for this operations combination includes a total of 12 selection patterns including: four selection patterns for Monday (first Monday to fourth Monday); four selection patterns for Wednesday (first Wednesday to fourth Wednesday); and four selection patterns for Friday (first Friday to fourth Friday). Similarly, cases where the update cycle 174 is every season and every quarter each also include a plurality of selection patterns.

While the selection patterns for the operations combination using the cycle restriction 184 and the day of the week or date restriction 185 only are as described above, the restriction-satisfying optimum operations combination-generating unit 126 can further identify selection patterns of the procurement plan for the U.S. sales company satisfying the restriction in the records 189 further including the update time point 176 and the required update time 178 in addition to these. Furthermore, for each plan or instruction from each sector, the restriction-satisfying optimum operations combination-generating unit 126 identifies selection patterns for the operations combination satisfying the restriction registered in the update timing restriction table 180 and the update method restriction table 190 in FIG. 8 in a similar manner, and generates all possible combinations of the identified selection patterns as the operations combinations for the supply chain, and registers the combinations in the satisfaction derivation operations combination table 230 in FIG. 12. For the plan or instruction 173 not registered in the update timing restriction table 180 or the update method restriction table 190, the restriction-satisfying optimum operations combination-generating unit 126 identifies all the possible selection patters as the selection patterns for the plans or instructions 183 and 193.

The restriction-satisfying optimum operations combination-generating unit 126 may employ various methods for reducing the number of operations combinations to be generated. For example, if “every week” is registered as the cycle restriction 184 in the update timing restriction table 180, the restriction-satisfying optimum operations combination-generating unit 126 may use only “every week” as the selection pattern for the update cycle, such that lower frequencies such as “every month” and “every season” are not included as the selection pattern. Furthermore, the restriction-satisfying optimum operations combination-generating unit 126 may generate operations combinations for the supply chain, with the content of the plan or instruction 173 from the sector 172 not registered in the update timing restriction table 180 or the update method restriction table 190 being fixed to the contents registered in the plan or instruction operation parameter table 170 instead of identifying all possible selection patterns therefor.

FIG. 8 is a diagram illustrating an example of an update method restriction table stored in the operations restriction storage unit in FIG. 2.

In FIG. 8, the update method restriction table 190 includes a record in which model ID 191, sector 192, plan or instruction 193, and update logic restriction 194 are associated with each other.

The model ID 191, the sector 192, and the plan or instruction 193 are pieces of information that are similar to the items with the same names in the plan or instruction operation parameter table 170 in FIG. 6. The update logic restriction 194 is information for identifying a predetermined update logic that can be employed for updating a plan or instruction.

FIG. 9 is a diagram illustrating an example of a restriction change table stored in the operations restriction storage unit in FIG. 2.

In FIG. 9, the restriction change table 200 includes a record in which restriction 201 and changeability 202 are associated with each other.

The restriction 201 includes cycle restriction, day of the week or date restriction, time restriction, required update time restriction, and update logic restriction for the items stored in the plan or instruction operation parameter table 170 in FIG. 6. The changeability 202 is information indicating the order of changeability of the five restrictions described above.

The update timing restriction table 180 in FIG. 7 and the update method restriction table 190 in FIG. 8 are used for generating the satisfaction derivation operations combination table 230 in FIG. 12. The restriction change table 200 in FIG. 9 is used for generating the relaxation derivation operations combination table 250 in FIG. 13.

FIG. 10 is a diagram illustrating an example of a priority table stored in the update timing storage unit in FIG. 2.

In FIG. 10, the priority table 210 includes a record in which model ID 211 and priority 212 are associated with each other.

The model ID 211 is information similar to the item with the same name in the model name table 140 in FIG. 3. The priority 212 is information indicating the priority of each of a plurality of supply chain models for deriving the optimum operations combination.

FIG. 11 is a diagram illustrating an example of a timing of proposal table stored in the update timing storage unit in FIG. 2.

In FIG. 11, the timing of proposal table 220 includes a record in which model ID 221, next timing of proposal 222, timing of proposal 223, and repeated time(s) 224 are associated with each other.

The model ID 221 is information that is similar to the item with the same name in the model name table 140 in FIG. 3. The next timing of proposal 222 is information holding date and time of the next timing at which the operations combination with the relaxed restriction is to be proposed. The proposal interval 223 is information (one time only, every other week, or every other day) that holds an interval at which the operations combination with the relaxed restriction is proposed and is input through the client 4. The repeated time(s) 224 is information holding the number of times the timings at which the operations combination with the relaxed restriction is proposed are repeated at the proposal interval 223.

The priority table 210, in FIG. 10 and the timing of proposal table 220 in FIG. 11 are used for generating the scheduling table 280 in FIG. 15.

FIG. 12 is a diagram illustrating an example of a satisfaction derivation operations combination table stored in the operations combination storage unit in FIG. 2.

In FIG. 12, the satisfaction derivation operations combination table 230 includes a record in which model ID 231, combination ID 232, sector 233, plan or instruction 234, update cycle 235, update day of the week or date 236, update time point 237, standard time 238, required update time 239, update method 240, and evaluation KPI 241 are associated with each other.

The model ID 231, the sector 233, the plan or instruction 234, the update cycle 235, the update day of the week or date 236, the update time point 237, the standard time 238, the required update time 239, and the update method 240 are pieces of information that are similar to the respective items with the same names in the plan or instruction operation parameter table 170 in FIG. 6. The combination ID 232 is information identifying a single combination from combinations of update timings and methods for each plans or instructions from each sector constituting a supply chain corresponding to a single supply chain model. The evaluation KPI 241 is information indicating an evaluation index calculated for each single combination described above.

The evaluation KPI is calculated, for example, with a predetermined method on the basis of a predetermined index reference such as logistics and/or cashflows in the entire supply chain. For example, the evaluation KPI can be calculated through supply chain simulation using a discrete simulation technique described in Japanese Patent Application Publication No. 2002-145421.

FIG. 12 illustrates an example where, for a model with the model ID of 01, the combination ID 232 of a single combination of the update timings and methods for each plan or instruction from each sector is set to be 340, and the evaluation KPI 241 of this combination is calculated as 460 MY.

FIG. 13 is a diagram illustrating an example of a relaxation derivation operations combination table stored in the operations combination storage unit in FIG. 2.

In FIG. 13, the relaxation derivation operations combination table 250 includes a record in which, model ID 251, combination ID 252, sector 253, plan or instruction 254, update cycle 255, update day of the week or date 256, update time point 257, standard time 258, required update time 259, update method 260, evaluation KPI 261, and relaxation effect value 262, derivation end flag 263 are associated with each other.

The model ID 251, the combination ID 252, the sector 253, the plan or instruction 254, the update cycle 255, the update day of the week or date 256, the update time point 257, the standard time 258, the required update time 259, and the update method 260 are pieces of information that are similar to the respective items with the same names in the satisfaction derivation operations combination table 230 in FIG. 12. The evaluation KPI 261 is an evaluation KPI for each single combination after the restriction is relaxed. The relaxation effect value 262 is information indicating the effect of relaxation on each single combination after the restriction is relaxed. The relaxation effect value 262 is a value obtained by subtracting the highest evaluation KPI 241 obtained as a result of restriction-satisfying optimum operations combination with none of relaxed restriction, from the evaluation KPI 261 of the operations combination after the restriction relaxation. The derivation end flag 263 is information for identifying whether the restriction-satisfying optimum operations combination after the restriction relaxation has been completed (T) for each single combination, or is not completed (F).

For example, it is assumed that in the satisfaction derivation operations combination table 230 in FIG. 12, the update cycle 235 for “production plan” of “Japanese factory” in the combination with the combination ID 232 of 340 is relaxed from every week to every month, and the update day of the week or date 236 is changed from Thursday to the first Thursday due to the relaxation. As a result, in the relaxation derivation operations combination table 250 in FIG. 13, the combination ID 252 is changed to 440, the update cycle 255 for the “production plan” of the “Japanese factory” is set to be every month, and the update day of the week or date 256 is set to be the first Thursday. If the evaluation KPI 261 after the restriction relaxation is calculated to be 400 MY, the relaxation effect value 262 is calculated to be −60 MY. The derivation end flag 263 is set to be T.

FIG. 14 is a diagram illustrating an example of a derivation time table stored in the derivation time storage unit in FIG. 2. In FIG. 14, the derivation time table 270 includes a record in which model ID 271, satisfaction derivation time 272, and estimated relaxation derivation time 273 are associated with each other.

The model ID 271 is information that is similar to the item with the same name in the model name table 140 in FIG. 3. The satisfaction derivation time 272 is information indicating a time required for deriving a restriction-satisfying optimum operations combination for a single supply chain model. The satisfaction derivation time 272 is not limited to an actual time it took for deriving the restriction-satisfying optimum operations combination and may be a derivation time for the restriction-satisfying optimum operations combination estimated from the supply chain model configuration. The estimated relaxation derivation time 273 is information indicating a time estimated to be required for deriving the restriction relaxing optimum operations combination for a single supply chain model.

FIG. 15 is a diagram illustrating an example of a scheduling table stored in the scheduling storage unit in FIG. 2.

In FIG. 15, the scheduling table 280 includes a record in which schedule number 281, model ID 282, and timing of proposal 283 are associated with each other.

The model ID 282 and the timing of proposal 283 are pieces of information that are similar to the respective items with the same names in the timing of proposal table 220. The schedule number 281 is information with which records are numbered in the descending order from the highest level record when the scheduling table 280 is generated, and is used for identifying a combination between the model ID 282 and the timing of proposal 283.

For example, when the priority table 210 in FIG. 10 and the timing of proposal table 220 in FIG. 11 are set, next timing of proposal “2017/12/02 10:00:00” of the model ID=03 with the highest priority is registered in the scheduling table 280. The repeated times for the model ID=03 is “1”, and thus, a similar process is performed for the model ID=01 with the second highest priority. The repeated times and the proposal interval for the model ID=02 with the next highest priority are respectively “2” and “every other week”. Thus, the next timing of proposal “2017/12/04 0:00:00” and “2017/12/11 0:00:00”, the week after, are registered in the scheduling table 1215. In this manner, the timing of proposal 283 is added to the scheduling table 280 for each model on the basis of the priority.

The derivation time table 270 in FIG. 14 and the scheduling table 280 in FIG. 15 are used for generating the execution timing table 290 in FIG. 16.

FIG. 16 is a diagram illustrating an example of an execution timing table stored in the scheduling storage unit in FIG. 2.

In FIG. 16, the execution timing table 290 includes a record in which model ID 291, derivation start date and time 292, derivation end date and time 293, execution flag 294, and derivation ratio 295 are associated with each other.

The model ID 291 is information that is similar to the item with the same name in the model name table 140 in FIG. 3. The derivation start date and time 292 is information indicating the date and time at which derivation of the restriction relaxing optimum operations combination starts. It may be the date and time at which the derivation of the restriction-satisfying optimum operations combination starts, in a case where the restriction-satisfying optimum operations combination is scheduled. The derivation end date and time 293 is information indicating the date and time at which the derivation of the restriction relaxing optimum operations combination ends. It may be the date and time at which the derivation of the restriction-satisfying optimum operations combination ends when the restriction-satisfying optimum operations combination is scheduled. The execution flag 294 is information for identifying whether the derivation for the optimum operations combination is being performed (T) or is not being performed (F). The derivation ratio 295 is information indicating a ratio of the operations combinations that have been derived to all possible operations combinations for the target model ID in the satisfaction derivation operations combination table 230 in FIG. 12 and in the relaxation derivation operations combination table 250 in FIG. 13.

When the derivation start date and time 292 and the derivation end date and time 293 are set for each model ID, the estimated relaxation derivation time 273 in FIG. 14 is acquired as a vacant time before the timing of proposal 283 corresponding to each model ID 291 in accordance with the priority of the model ID 291. The derivation start date and time 292 and the derivation end date and time 293 are set to be in the vacant time acquired for each model ID 291. The vacant time acquired for each model ID 291 may be continuous or may be discontinuous. The vacant time is a time not corresponding to periods between the derivation start date and time and the derivation end date and time of all the models that have been determined to be after the current date and time.

For example, when the execution timing table 290 is empty, the vacant time for the record 284 in the scheduling table 280 in FIG. 15 is acquired. When the execution timing table 290 is empty, the time after the current date and time is entirely vacant. Thus, the start timing and the end timing of the available time for the record 284 in the scheduling table 280 are respectively “current date and time” and “2017/12/02 10:00:00” matching the timing of proposal in the record 284. Note that the current is “2017/12/01 00:00:00”.

The remaining derivation time for the record 284 in the scheduling table 280 is “15 hours” which matches the estimated relaxation derivation time 273 for the model ID=03 in FIG. 14. Thus, a record 296 with a derivation start date and time 292 of “2017/12/01 19:00:00” as a result of subtracting the remaining derivation time from the end timing of the vacant time and a derivation end date and time 293 of “2017/12/02 10:00:00” that is the end timing of the vacant time is added to the execution timing table 290. Here, the derivation ratio 295 in the record 296 is 100% because “15 hours” matching the estimated relaxation derivation time 273 is secured between the derivation start date and time 292 and the derivation end date and time 293.

In a record 285 in the scheduling table 280, the derivation end date and time 293 is “2017/12/01 09:00:00” corresponding to the timing of proposal 283 for the model ID=01 in FIG. 15. The derivation start date and time 292 is supposed to be “2017/11/30 13:00:00” that is 20 hours earlier and corresponds to the estimated relaxation derivation time 273 for the model ID=01 in FIG. 14, but the current date and time is “2017/12/01 00:00:00”. Thus, in the record 285 in the scheduling table 280, the derivation start date and time 292 is “2017/12/01 00:00:00” which is the current date and time, meaning that the maximum time available from the derivation end date and time 293 is only nine hours. Thus, the record 297 with the derivation ratio 295 of 9/20=45% is added to the execution timing table 290 for the record 285 in the scheduling table 280.

The vacant time of the record 286 in the scheduling table 280 in FIG. 15 is assumed to be acquired in a state where the records 296 to 298 are registered in the execution timing table 290 in FIG. 16. The timing of proposal “2017/12/01 08:00:00” in the record 286 of the scheduling table 280 is included within a period between the derivation start date and time 292 and the derivation end date and time 293 in the record 297 of the execution timing table 290. Thus, the start timing and the end timing of the vacant time in the record 286 are respectively “current date and time” and the derivation start date and time “2017/12/01 00:00:00” in the record 297. The vacant time of the record 286 is “none” because the end timing of the vacant time matches the current date and time. Thus, no record of the execution timing table 290 is registered for the record 286 of the scheduling table 280.

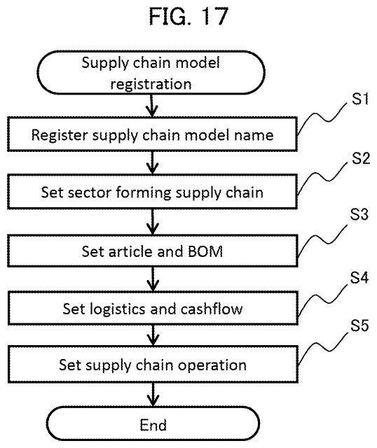

FIG. 17 is a flowchart illustrating an example of a supply chain model registration process.

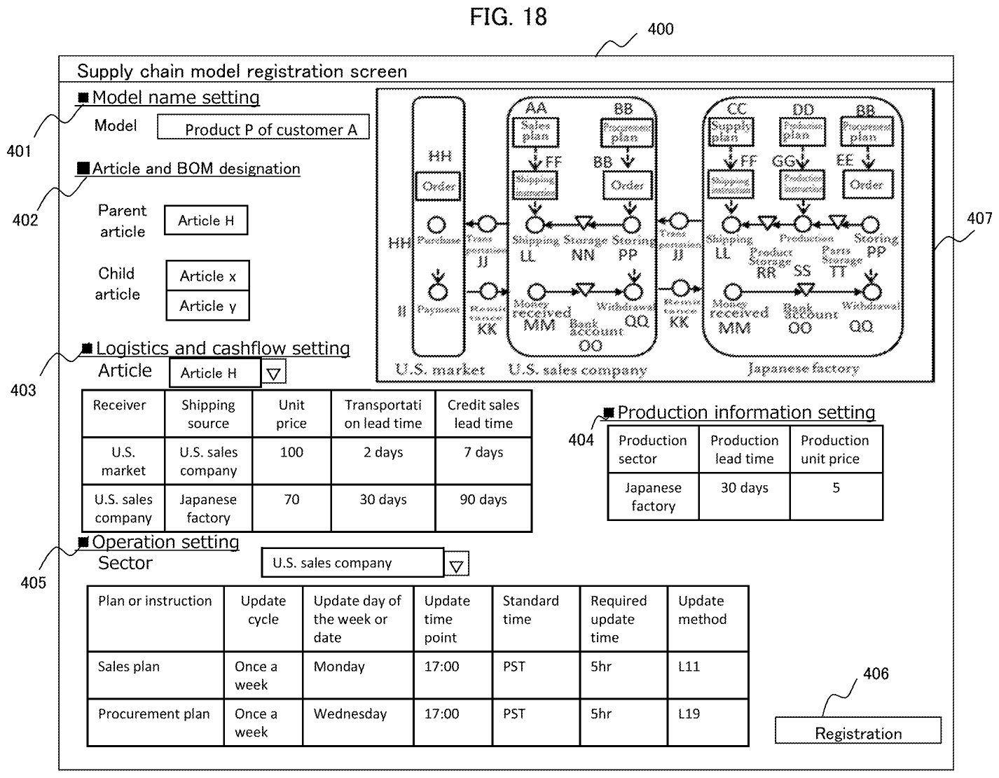

In FIG. 17, the supply chain model registration unit 123 in FIG. 2 starts the process when the input reception unit 121 receives an execution instruction from the client 104. Upon starting the process, the supply chain model registration unit 123 causes the supply chain model registration screen 400 in FIG. 18 to be displayed as a screen for inputting predetermined information through the output process unit 122.

FIG. 18 is a diagram illustrating an example of a supply chain model registration screen.

On the supply chain model registration screen 400 in FIG. 18, model name setting field 401, article and BOM designation field 402, logistics and cashflow setting field 403, production information setting field 404, operation setting field 405, registration button 406, and supply chain configuration 407 are displayed.

The model name setting field 401 displays a model name for which a free description input has been received. The article and BOM designation field 402 displays article names of parent and child articles for which selection inputs have been received. The logistics and cashflow setting field 403 receives selection inputs for receiver, shipping source, unit price, transportation lead time, credit sales reception lead time corresponding to the article for which the selection input has been received. The production information setting field 404 receives a selection input for production sector, production lead time, and production unit price corresponding to the article for which the selection input has been received. The operation setting field 405 receives selection inputs for plan or instruction, update cycle, update day of the week or date, update time point, standard time, required update time, update method corresponding to a sector for which the selection input has been received. The registration button 406 is used for registering the information received through the supply chain model registration screen 400.

For example, in the supply chain 407, the U.S. market (consumer) orders a product to a U.S. sales company and pays the money when the purchasing of the product is completed. The U.S. sales company drafts a sales plan and drafts a procurement plan on the basis of the sales plan. The U.S. sales company orders a product to a Japanese factory on the basis of the procurement plan, stores the product in a storage when the product is transported from the Japanese factory, and then pays the money to the Japanese factory. The U.S. sales company generates a shipment instruction on the basis of the order from the U.S. market and the sales plan, ships the product from the storage to the U.S. market on the basis of the shipment instruction, and receives the money from the U.S. market.

The Japanese factory drafts a supply plan on the basis of the procurement plan of the U.S. sales company, drafts a production plan on the basis of the supply plan, and drafts a procurement plan on the basis of the production plan. The Japanese factory orders parts on the basis of the procurement plan, and when the part is transported, stores the part in the part storage and pays the money to the supplier. The Japanese factory generates a production instruction on the basis of the production plan, ships the part from the part storage on the basis of the production instruction to produce the product and stores the completed product in the product storage. The Japanese factory generates a shipping instruction on the basis of the supply plan and the order from the U.S. sales company, and ships the product from the product storage to the U.S. sales company on the basis of the shipping instruction and receives the money from the U.S. sales company.

In FIG. 17, the supply chain model registration unit 123 in FIG. 1 registers the supply chain model name (S1), upon causing the supply chain model registration screen 400 to be displayed. Specifically, the supply chain model registration unit 123 acquires input information (information about the supply chain model name) to an input field through the input reception unit 121 and registers the information in the model name 142 in the model name table 140 in FIG. 3. Here, the supply chain model registration unit 123 causes the supply chain model registration screen 400 to be displayed on the output device through the output process unit 122, with the model name setting field 401 of the supply chain model registration screen 400 being capable of receiving free description input through the input reception unit 121, and thus receives the free description input from the user.

Next, the supply chain model registration unit 123 sets the sector constituting the supply chain (S2). Specifically, the supply chain model registration unit 123 acquires the input information (information identifying the supply chain configuration sector) to the input field through the input reception unit 121, to set the sector constituting the supply chain.

For example, for the supply chain 407 in FIG. 18, the supply chain model registration unit 123 acquires pieces of information for identifying the U.S. market, the U.S. sales company, and the Japanese factory as the input information. These pieces of information are registered in the sector 172 in the plan or instruction operation parameter table 170 in FIG. 6. The supply chain model registration unit 123 extracts a corresponding plan or instruction from a plan or instruction list information stored in advance as a template for each of types (“market”, “sales company”, and “factory”) of the sector 172, and registers such pieces of information in the plan or instruction 173 in the plan or instruction operation parameter table 170 in association with each sector 172. For example, in the plan or instruction list information, a plan or instruction such as “sales plan”, “procurement plan”, “shipping instruction”, and “order” are associated with the sector type “sales company”.

Next, the supply chain model registration unit 123 sets the article and BOM (Bills Of Materials) (S3). Specifically, the supply chain model registration unit 123 acquires information related to the article and BOM input to the input field through the input reception unit 121 and registers the information in the article 154 of the inter-sector transaction condition parameter table 150 in FIG. 4. In this process, the supply chain model registration unit 123 displays the supply chain model registration screen 400 in FIG. 18 with the article and BOM designation field 402 being capable of receiving the information related to the article and BOM, and to receive the selection input from the user.

Next, the supply chain model registration unit 123 sets the logistics and cashflow (S4). Specifically, the supply chain model registration unit 123 acquires pieces of information related to the receiver and the shipping source of the article input to the input field through the input reception unit 121 and registers the respective pieces of information in the To sector 152 and the From sector 153 in the inter-sector transaction condition parameter table 150. The supply chain model registration unit 123 acquires the unit price, the transportation lead time, and the credit sales reception lead time of the article input to the input field through the input reception unit 121, and registers each of these pieces information in the item field with the same name in the inter-sector transaction condition parameter table 150. In this process, the supply chain model registration unit 123 displays the supply chain model registration screen 400 with the logistics and cashflow setting field 403 being selectable for each article, to receive the selection input from the user.

The supply chain model registration unit 123 causes the supply chain model registration screen 400 to be displayed as an input screen for predetermined information through the output process unit 122, to acquire pieces of information related to the sector that produces the article acquired in step S3, the production lead time, and the production unit price through the input reception unit 121. The supply chain model registration unit 123 registers each of the acquired pieces of information in the item field of the same name in the production condition parameter table 160 in FIG. 5. In this process, the supply chain model registration unit 123 displays the supply chain model registration screen 400 with the production information setting field 404 being selectable for each article, to receive the selection input from the user.

Next, the supply chain model registration unit 123 sets the supply chain operation (S5). Specifically, the supply chain model registration unit 123 acquires pieces of information related to the update cycle, the update day of the week or date, the update time point, the standard time, the required update time, and the update method corresponding to the sector and plan or instruction input to the input fields through the input reception unit 121, and stores each of these pieces of information in the item field of the same name in the plan or instruction operation parameter table 170 in FIG. 6. In this process, the supply chain model registration unit 123 displays the supply chain model registration screen 400 with the operation setting field 405 being selectable for each sector, to receive a selection input from the user.

If information identifying the location of the sector is stored in the memory 112 of the supply chain operations process optimization device 101 in advance, the supply chain model registration unit 123 identifies the standard time from this information and perform the registration. When there is a template in which the plan or instruction and the update method are associated with each other prepared in advance, the supply chain model registration unit 123 may use such a template to register the update method corresponding to the plan or instruction identified. For example, the supply chain model registration unit 123 may acquire the article and the BOM information from the factory operation PC 102 through a network and perform the registration.

When the registration button 406 on the supply chain model registration screen 400 is pressed, the supply chain model registration unit 123 numbers the model name freely input and the model ID for uniquely identifying the model name, and registers each of the resultant pieces of information to an item field with the same name in the model name table 140 in FIG. 3. The supply chain model registration unit 123 stores the information in the model ID 211 and the priority 212 in the priority table 210 in FIG. 10 with the numbered model ID corresponding to the lowest priority. The supply chain model registration unit 123 registers each of the numbered model ID as well as the To sector, the From sector, article, the unit price, the transportation lead time, the credit sales reception lead time, the production lead time, the production unit price, the update cycle, the update day of the week or date, the update time point, the standard time, the required update time, and the update method that have been selected and input in the item field with the same name in the inter-sector transaction condition parameter table 150 in FIG. 4, the production condition parameter table 160 in FIG. 5, and the plan or instruction operation parameter table 170 in FIG. 6.

When the process in step S5 is completed, the supply chain model registration unit 123 terminates the supply chain model registration process.

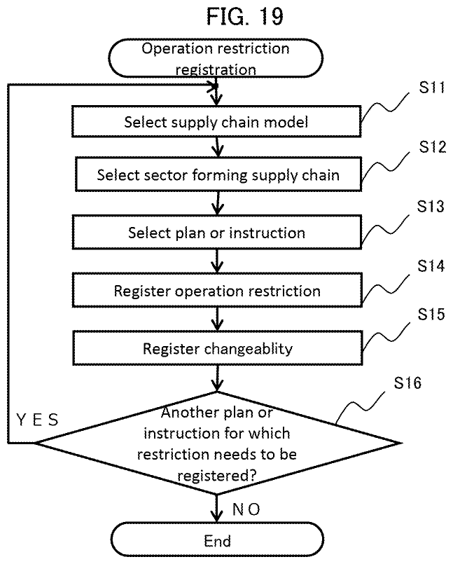

FIG. 19 is a flowchart illustrating an example of an operations restriction registration process.

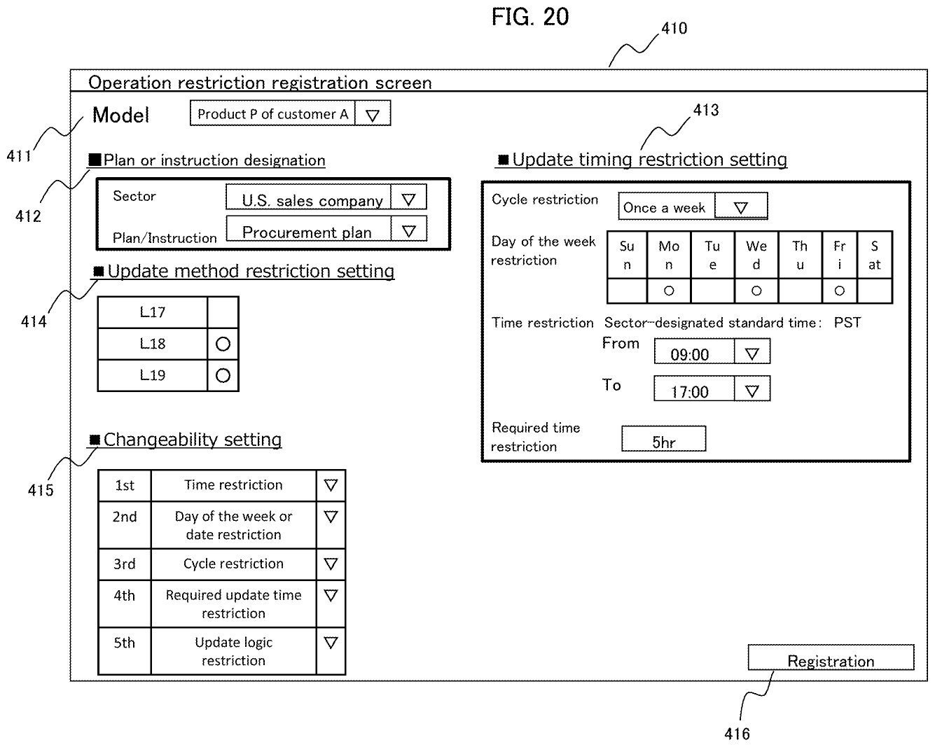

In FIG. 19, the operations restriction registration unit 124 in FIG. 2 starts the process when the input reception unit 121 receives an execution instruction from the client 104. Upon starting the process, the operations restriction registration unit 124 causes the operations restriction registration screen 410 in FIG. 20 as an input screen for predetermined information, through the output process unit 122.

FIG. 20 is a diagram illustrating an example of an operations restriction registration screen.

On the operations restriction registration screen 410 in FIG. 20, a model field 411, a plan or instruction designation field 412, an update timing restriction setting field 413, an update method restriction setting field 414, a changeability setting field 415, and a registration button 416 are displayed.

The model field 411 is displayed to enable a model name registered in the model name table 140 in FIG. 3 to be selected. The plan or instruction designation field 412 is displayed to enable the sector 172 and the plan or instruction 173, registered in the plan or instruction operation parameter table 170 in FIG. 6, to be selected. The update timing restriction setting field 413 receives a selection input for the cycle restriction, the day of the week or date restriction, the time restriction, the standard time, and the required update time restriction. The update method restriction setting field 414 receives a selection input for the update logic. The changeability setting field 415 receives a selection input for the priority of each of “cycle restriction”, “day of the week or date restriction”, “time restriction”, “required update time restriction”, and “update logic restriction”.

In FIG. 19, the operations restriction registration unit 124 receives a selection input for the supply chain model for which the operations restriction is registered (S11), upon displaying the operations restriction registration screen 410. Specifically, the operations restriction registration unit 124 acquires information related to the model name input to the input field through the input reception unit 121. In this process, the operations restriction registration unit 124 acquires the model name corresponding to the model ID 171 registered in the plan or instruction operation parameter table 170 in FIG. 6, from the model name 142 in the model name table 140 in FIG. 3 and displays the operations restriction registration screen 410 with the model field 411 being selectable, to receive a selection input from the user.

Next, the operations restriction registration unit 124 receives selection inputs for the sector constituting the supply chain for which the operations restriction is registered and the plan or instruction (S12, S13). Specifically, the operations restriction registration unit 124 acquires information related to the sector constituting the supply chain and the plan or instruction, input to the input fields through the input reception unit 121. In this process, the operations restriction registration unit 124 displays the operations restriction registration screen 410 with the plan or instruction designation field 412 enabling the sector 172 and the plan or instruction 173 registered in the plan or instruction operation parameter table 170 in FIG. 6 to be selected, to receive the selection input from the user.

Next, the operations restriction registration unit 124 registers the operations restriction (S14). In this process, the operations restriction registration unit 124 displays the operations restriction registration screen 410 with the update timing restriction setting field 413 enabling the cycle restriction, the day of the week or date restriction, the time restriction, the standard time, and the required update time restriction to be selected and with the update logic displayed in update method restriction setting field 414, to receive the selection input from the user.

Next, the operations restriction registration unit 124 registers the changeability (S15). Specifically, for the “cycle restriction”, the “day of the week or date restriction”, the “time restriction”, the “required update time restriction”, and the “update logic restriction” as the changeable operations restrictions, the operations restriction registration unit 124 acquires information related to the changeability of the operations restriction input to the input field through the input reception unit 121, and registers the information in the changeability 202 in the restriction change table 200 in FIG. 9. In this process, the operations restriction registration unit 124 displays the operations restriction registration screen 410 with the changeability setting field 415 enabling these priorities to be selected, to receive the selection input from the user.

When the registration button 416 on the operations restriction registration screen 410 is pressed, the operations restriction registration unit 124 acquires the model ID in the model name table 140 in the supply chain model storage unit 130 on the basis of the model name for which the selection input has been received, acquires the model ID, and further, information on a sector that has received the selection input, and a plan or an instruction, the cycle restriction, the day of the week or date restriction, the time restriction, the standard time, and the required update time restriction to be selected, and the update logic, and stores each of these pieces of information in the corresponding item field in the update method restriction table 190 in FIG. 8 or the update timing restriction table 180 in FIG. 7. The operations restriction registration unit 124 registers the changeability for which the selection input has been received in the item field with the same name in the restriction change table 200 in FIG. 9.

Next, the operations restriction registration unit 124 determines whether there is another plan or instruction for which the restriction needs to be registered (S16). For example, the operations restriction registration unit 124 causes a dialog including an instruction button for receiving an instruction indicating whether the restriction registration is to be continued through the output process unit 122 and makes the determination on the basis of a response instruction from the user acquired from the client 104 through the input reception unit 121.

When pressing of the instruction button for instructing the restriction registration to be continued is received through the input reception unit 121 (YES in S16), the operations restriction registration unit 124 returns to step S11. When pressing of the instruction button for instructing not to continue the restriction registration is received through the input reception unit 121 (NO in S16), the operations restriction registration unit 124 terminates the operations restriction registration process.

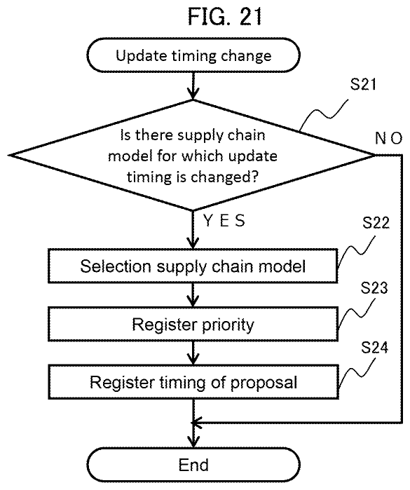

FIG. 21 is a flowchart illustrating an example of an update timing change process.

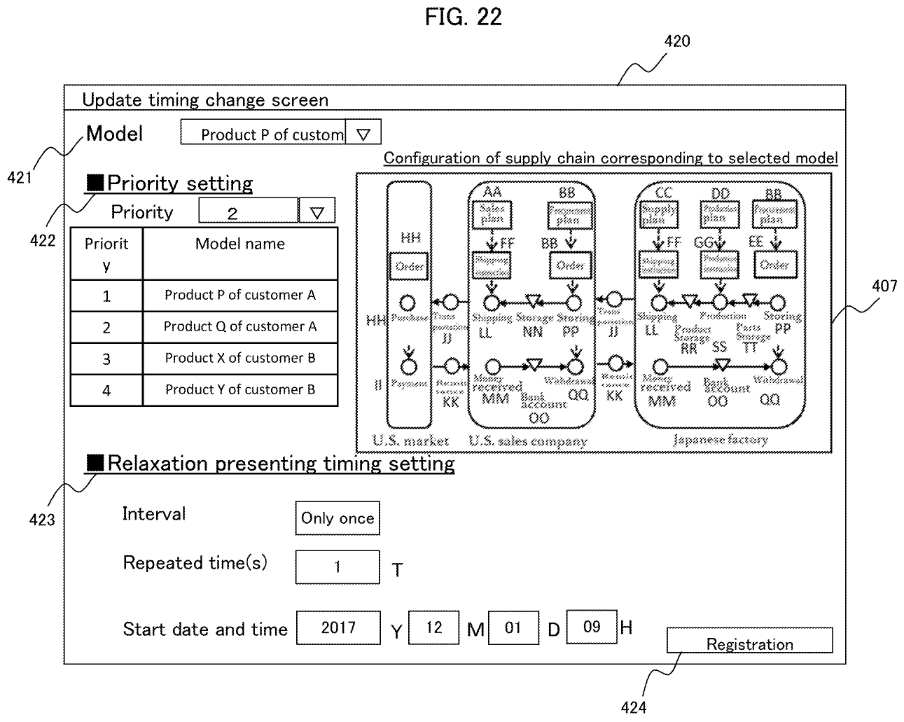

In FIG. 21, the update timing change unit 125 in FIG. 2 starts the process when the input reception unit 121 receives an execution instruction from the client 104. Upon starting the process, the update timing change unit 125 causes the update timing change screen 420 in FIG. 22 to be displayed as an input screen for predetermined information, through the output process unit 122.

FIG. 22 is a diagram illustrating an example of an update timing change screen.

On the update timing change screen 420 in FIG. 22, a model field 421, a priority setting field 422, a relaxation proposing timing setting field 423, and a registration button 424 are displayed.

The model field 421 is displayed to enable a model name registered in the model name table 140 to be selected. The priority setting field 422 is displayed with the priority 212 registered in the priority table 210 in FIG. 10, to receive a selection input for the priority. The relaxation proposing timing setting field 423 receives a user input for the proposal interval 223, the repeated time(s) 224, and the next timing of proposal 222 registered in the timing of proposal table 220 in FIG. 11.

In FIG. 21, the update timing change unit 125 determines whether there is a supply chain model for which the update timing for displaying the update timing change screen 420 is changed (S21). For example, the update timing change unit 125 causes displaying of a dialog including an instruction button for receiving an instruction whether there is a supply chain model for which the update timing is changed through the output process unit 122 and makes the determination on the basis of the user's response information acquired from the client 104 through the input reception unit 121.

When pressing of an instruction button for instructing that there is no supply chain model for which the update timing is changed is accepted through the input reception unit 121 (NO in S21), the update timing change unit 125 terminates the update timing change process. When pressing of an instruction button for instructing that there is a supply chain model for which the update timing is changed is accepted through the input reception unit 121 (YES in S21), the update timing change unit 125 proceeds to step S22.

Next, the update timing change unit 125 receives the selection input for the supply chain model for which the update timing change is to be performed (S22). Specifically, the update timing change unit 125 acquires the model name corresponding to the model ID 171 registered in the plan or instruction operation parameter table 170 in FIG. 6 through the model name 142 in the model name table 140 in FIG. 3 and displays the name on the model field 421 of the update timing change screen 420 to be selectable to receive a selection input from the user. The update timing change unit 125 causes the configuration of the supply chain 407 corresponding to the selected model on the update timing change screen 420.

Next, the update timing change unit 125 receives a selection input for the priority for the supply chain 407 for which the update timing is changed (S23). Specifically, the update timing change unit 125 causes the priority setting field 422 of the update timing change screen 420 to be displayed to enable the priority 212 registered in the priority table 210 in FIG. 10 to be selected, to receive a selection input from the user. The update timing change unit 125 also causes the priority of the supply chain before the update timing is changed, to be displayed on the update timing change screen 420.

Next, the update timing change unit 125 receives an input for the timing of proposal at which the update timing (S24). Specifically, the update timing change unit 125 causes the proposal interval 223, the repeated time(s) 224, and the next timing of proposal 222 registered in the timing of proposal table 220 in FIG. 11 on the relaxation proposing timing setting field 423 in the update timing change screen 420, to receive an input change by the user. When the timing of proposal is set for the first time, the relaxation proposing timing setting field 423 is displayed as an empty field.

When the registration button 424 on the update timing change screen 420 is pressed, the update timing change unit 125 acquires the model ID of the model name table 140 in the supply chain model storage unit 130, on the basis of the model name for which the selection input has been received, registers the model ID and the priority for which the selection input has been received in the priority 212 of the priority table 210 in FIG. 10, and stores each of the proposal interval, the repeated times, and the next timing of proposal for which the selection inputs have been received in the corresponding item field in the timing of proposal table 220 in FIG. 11.

On the basis of the model name table 140 stored in the supply chain model storage unit 130, the priority table 210 stored in the update timing storage unit 132, and the timing of proposal table 220, the update timing change unit 125 stores the model ID 282 and the timing of proposal 283 one by one in the corresponding item fields in the scheduling table 280 in FIG. 15 in accordance with the priority, to satisfy the proposal interval 223 and the repeated time(s) 224 stored in the timing of proposal table 220. The update timing change unit 125 provides the schedule number 281 for each timing of proposal 283 and stores the resultant information in the corresponding item field in the scheduling table 280.

When the process in in step S205 is completed, the update timing change unit 125 terminates the update timing change process.

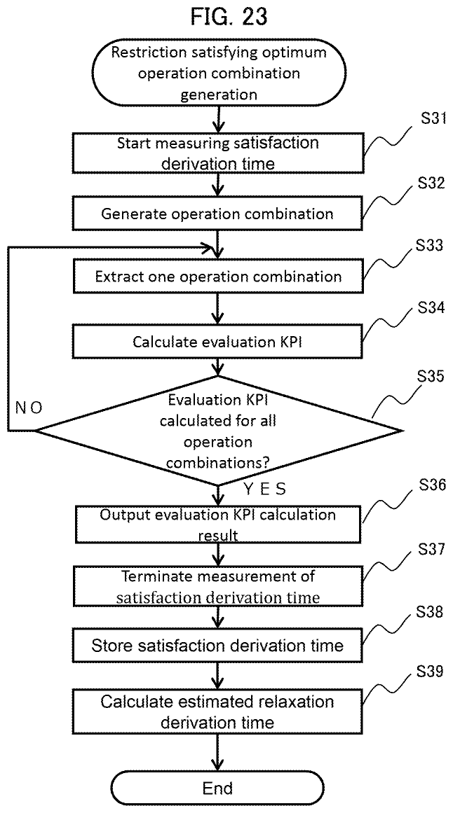

FIG. 23 is a flowchart illustrating an example of a restriction-satisfying optimum operations combination generation process.

In FIG. 23, the restriction-satisfying optimum operations combination-generating unit 126 in FIG. 2 starts a process in which the supply chain model registration unit 123, the operations restriction registration unit 124, and the update timing change unit 125 each store predetermined information. Alternatively, the restriction-satisfying optimum operations combination-generating unit 126 may start process in which the input reception unit 121 receives an execution instruction from the client 104, in a state where predetermined information is stored in each of the supply chain model storage unit 130, the operations restriction storage unit 131, and the update timing storage unit 132.

The restriction-satisfying optimum operations combination-generating unit 126 starts measuring the satisfaction derivation time which is a time required for deriving the restriction-satisfying optimum operations combination for the supply chain (S31). In this process, the restriction-satisfying optimum operations combination-generating unit 126 stores the date and time at the time when the restriction-satisfying optimum operations combination generation process is started, on the memory 112.

Next, the restriction-satisfying optimum operations combination-generating unit 126 generates the operations combination for the supply chain (S32). Specifically, the restriction-satisfying optimum operations combination-generating unit 126 refers to the plan or instruction operation parameter table 170 stored in the supply chain model storage unit 130, the update timing restriction table 180 and the update method restriction table 190 stored in the operations restriction storage unit 131, to store a non-overlapping operations combination for the supply chain that satisfies the predetermined restrictions registered in the restriction tables, in the satisfaction derivation operations combination table 230 in FIG. 12. The restriction-satisfying optimum operations combination-generating unit 126 provides the combination ID for each operations combination and stores the resultant information in the item field corresponding to the satisfaction derivation operations combination table 230.

Next, the restriction-satisfying optimum operations combination-generating unit 126 extracts one operations combination from the operations combinations registered in the satisfaction derivation operations combination table 230 (S33) and calculates the evaluation KPI 241 for the extracted operations combination (S34). For example, the restriction-satisfying optimum operations combination-generating unit 126 calculates the evaluation KPI 241 for the extracted operations combination, using a predetermined method (supply chain simulation using the discrete simulation technique described in Japanese Patent Application Publication No. 2002-145421 for example), on the basis of a predetermined evaluation index such as logistics and cashflow of the entire supply chain. The restriction-satisfying optimum operations combination-generating unit 126 stores the evaluation KPI 241 for the operations combination thus calculated, in the corresponding item field in the satisfaction derivation operations combination table 230.

The calculation for the evaluation KPI 241 is not limited to the method using the discrete simulation technique, and the value may be calculated using a regression formula, generated from the causal relationship between an operations process parameter and the evaluation KPI, and the like.

Next, the restriction-satisfying optimum operations combination-generating unit 126 determines whether the evaluation KPI has been calculated for all the operations combinations registered in the satisfaction derivation operations combination table 230 (S35) and returns to step S33 when there is an operations combination for which the evaluation KPI has not been calculated (NO in S35).

On the other hand, when the evaluation KPI has been calculated for all the operations combinations (YES in S35), the restriction-satisfying optimum operations combination-generating unit 126 outputs the evaluation KPI calculation results (S36). Specifically, the restriction-satisfying optimum operations combination-generating unit 126 sorts the operations combinations for the supply chain in the descending order from the one with the highest the evaluation KPI as a result of the calculation, and extracts a predetermined number (for example, four) of information pieces corresponding to the best operations combinations. The restriction-satisfying optimum operations combination-generating unit 126 may determine an evaluation KPI exceeding a predetermined threshold to be an evaluation KPI with good calculation result, and may extract a predetermined number (for example, four) of information pieces related to the operations combinations exceeding the evaluation KPI. After calculating the evaluation KPIs for all the operations combinations, the restriction-satisfying optimum operations combination-generating unit 126 displays the extracted information related to the operations combinations through the output process unit 122.

Next, the restriction-satisfying optimum operations combination-generating unit 126 terminates the measurement of time which is required for deriving all the restriction-satisfying optimum operations combinations for the supply chain, and which has been started to be measured in step S31 (S37), obtains the satisfaction derivation time from the measured time, and stores the time in the derivation time storage unit 134 (S38). In this process, the restriction-satisfying optimum operations combination-generating unit 126 stores the satisfaction derivation time measured when all the operations combinations are generated, in the satisfaction derivation time 272 in the derivation time table 270 in FIG. 14.

Next, the restriction-satisfying optimum operations combination-generating unit 126 calculates the estimated relaxation derivation time that is an estimated time required for deriving the restriction relaxing optimum operations combination on the basis of the restriction-satisfying optimum operations combination derivation time for the supply chain (S39). Specifically, the restriction-satisfying optimum operations combination-generating unit 126 uses the satisfaction derivation time acquired in step S38, to calculate the estimated relaxation derivation time. For example, the number of restriction relaxing optimum operations combinations is proportional to the number of restriction-satisfying optimum operations combination restrictions and the number of plans and instructions, and thus the satisfaction derivation time is multiplied by the number of restrictions and then is multiplied by the number of plans or instructions, to obtain the estimated relaxation derivation time. The restriction-satisfying optimum operations combination-generating unit 126 stores the estimated relaxation derivation time thus calculated, in the estimated relaxation derivation time 273 in the derivation time table 270.

When the process in step S39 is completed, the restriction-satisfying optimum operations combination-generating unit 126 terminates the restriction-satisfying optimum operations combination generation process.

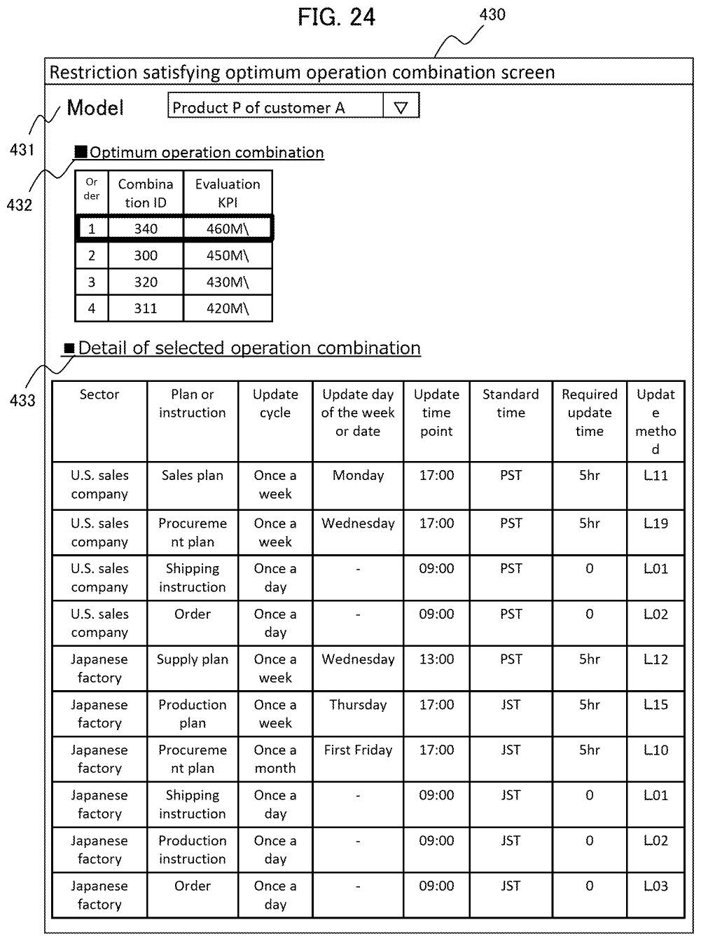

FIG. 24 is a diagram illustrating an example of a restriction-satisfying optimum operations combination screen. On the restriction-satisfying optimum operations combination screen 430 in FIG. 24, a model selection field 431, an optimum operations combination display field 432, and a detail display field 433 for the selected operations combination.

In the model selection field 431, a model name for which the selection input has been received is displayed. The orders of a predetermined number of (four for example) operations combinations with the best evaluation KPI calculation results, as well as the combinations ID and the evaluation KPIs thereof are displayed on the optimum operations combination display field 432. In the detail display field 433 for the selected operations combinations, detail information about the combination selected from the user from the combinations displayed on the optimum operations combination display field 432.

The restriction-satisfying optimum operations combination-generating unit 126 extracts detail information from the satisfaction derivation operations combination table 230 in FIG. 12 using a key that is the combination ID of a certain operations combination selected by the user from the operations combinations displayed on the optimum operations combination display field 432 and causes the detail display field 433 to display the information through the output process unit 122.

For example, a combination with the combination ID of 340 is assumed to be selected from the combinations displayed on the optimum operations combination display field 432. Assuming that the combination with the combination ID of 340 corresponds to the combination registered in the satisfaction derivation operations combination table 230 in FIG. 12, the sector 233, the plan or instruction 234, the update cycle 235, the update day of the week or date 236, the update time point 237, the standard time 238, the required update time 239, and the update method 240 in FIG. 12 are displayed on the detail display field 433. The combination ID 232 and the evaluation KPI 241 in FIG. 12 are displayed on the optimum operations combination display field 432.

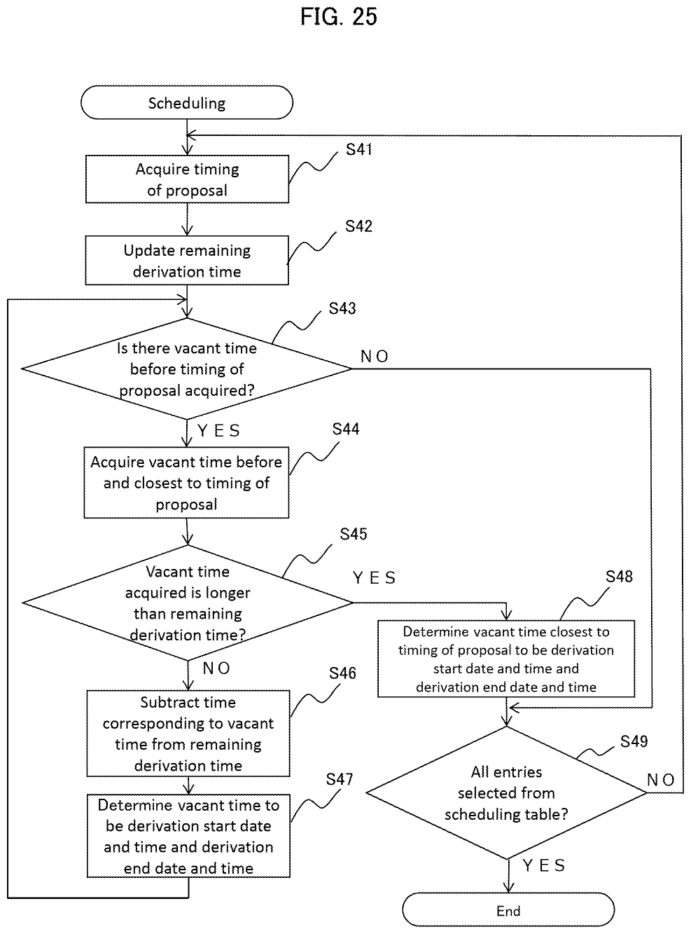

FIG. 25 is a flowchart illustrating an example of a scheduling process.

In FIG. 25, the scheduling unit 127 in FIG. 2 starts the process when the restriction-satisfying optimum operations combination generation process is terminated.

The scheduling unit 127 acquires the timing of proposal for a target model for which the derivation start date and time and the derivation end date and time for the restriction relaxing optimum operations combination are to be determined (S41). Specifically, the scheduling unit 127 acquires the model IDs 282 and the timing of proposals 283 in the ascending order of the schedule number 281 in the scheduling table 280 stored in the scheduling storage unit 135.

Next, the scheduling unit 127 registers the time required for deriving the restriction relaxing optimum operations combination for the model for which the information has been acquired in step S41, in the remaining derivation time (S42). Specifically, the scheduling unit 127 acquires the estimated relaxation derivation time for the model for which the information has been acquired in step S41 from the derivation time table 270 in FIG. 14, as the remaining derivation time.

Next, the scheduling unit 127 determines whether there is a vacant time before the timing of proposal acquired in step S41 (S43) and proceeds to step S49 when there is no vacant time before the timing of proposal (NO in S43).

When there is a vacant time before the timing of proposal (YES in S43), the scheduling unit 127 acquires a vacant time that is earlier than and closest to the timing of proposal acquired in step S41 (S44). Specifically, the scheduling unit 127 refers to the execution timing table 290 in FIG. 16 and acquires the vacant time that is earlier than and closest to the timing of proposal acquired in step S41. In this case, the derivation start date and time 292 and the derivation end date and time 293 that have been determined are stored in the execution timing table 290.

Next, the scheduling unit 127 determines whether the vacant time acquired in step S44 is longer than the remaining derivation time (S45), and when the vacant time is shorter than the remaining derivation time (NO is S45) and allocates the entire vacant time to the derivation time and subtracts a time corresponding to the vacant time from the remaining derivation time (S46). Specifically, the scheduling unit 127 updates the remaining derivation time by subtracting the vacant time acquired in step S44 from the remaining derivation time.

Next, the scheduling unit 127 determines the start date and time and the end date and time for the vacant time respectively to be the derivation start date and time and the derivation end date and time (S47). Specifically, the scheduling unit 127 adds an entry to the execution timing table 290 with the start date and time and the end date and time for the vacant time acquired in step S44 respectively set as the derivation start date and time 292 and the derivation end date and time 293, stores each of the timings in the corresponding item field and returns the S43.

On the other hand, when the vacant time is longer than the remaining derivation time (YES in S45), the scheduling unit 127 allocates a vacant time closest to the timing of proposal and determines the derivation start date and time and the derivation end date and time (S48). Specifically, the scheduling unit 127 subtracts the remaining derivation time from the end timing of the vacant time and adds an entry to the execution timing table 290 with the resultant date and time being the derivation start date and time 292 and the end timing of the vacant time being the derivation end date and time 293 and stores the information in the corresponding item field.

Next, the scheduling unit 127 determines whether all entries have been selected from the scheduling table 280 in FIG. 15 (S49) and terminates the scheduling process if all the entries have been selected (YES in S49). On the other, when there is an entry that has not been selected from the scheduling table 280 is remaining (NO in S49), the scheduling unit 127 returns to step S41.

For example, the scheduling unit 127 can generate the execution timing table 290 in FIG. 16 by executing the scheduling process on all the entries that have been registered in the scheduling table 280 in FIG. 15.

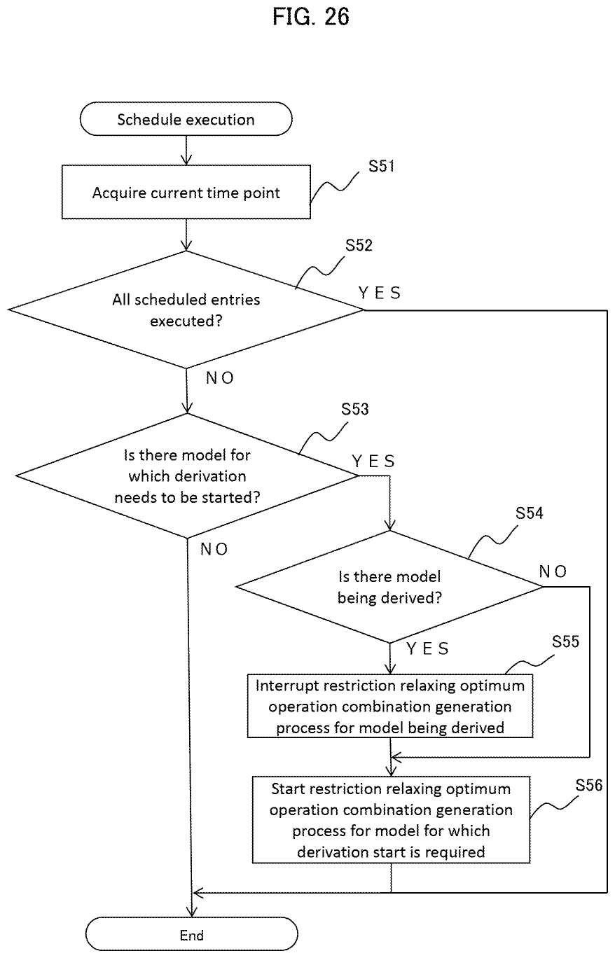

FIG. 26 is a flowchart illustrating an example of a schedule execution process.

In FIG. 26, the schedule execution unit 128 in FIG. 2 periodically starts the schedule execution process while monitoring the execution timing table 290 after the scheduling process has started. The schedule execution unit 128 acquires the current time point at which the schedule execution process is started (S51).

Next, the schedule execution unit 128 refers to the execution timing table 290 to determine whether all the scheduled entries have been executed (S52). When there is no unexecuted model in the scheduled entries (YES in S52), the schedule execution unit 128 terminates the schedule execution process. On the other hand, when there is an unexecuted model in the scheduled entries (NO in S52), the schedule execution unit 128 proceeds to S53.

Specifically, the schedule execution unit 128 refers to the derivation start date and time 292 in the execution timing table 290 in FIG. 16 to determine whether there is an entry with the derivation start date and time 292 at or after the current time point (S52). When there is no entry with the derivation start date and time at or after the current time point (YES in S52), the schedule execution unit 128 determines that the derivation for all the entries in the execution timing table 290 have been completed or is under progress, and thus terminates the schedule execution process. On the other hand, when there is an entry with the derivation start date and time 292 at or after the current time point (NO in S52), the schedule execution unit 128 proceeds to step S53.

Next, the schedule execution unit 128 refers to the execution timing table 290 and determines whether there is a model for which the derivation needs to be started next (S53), and if there is no model for which the derivation start is required (NO in S53), the schedule execution unit 128 terminates the schedule execution process. On the other hand, when there is a model for which the derivation start is required (YES in S53), the schedule execution unit 128 proceeds to step S54.

Specifically, the schedule execution unit 128 refers to the derivation start date and time 292, the execution flag 294, and the derivation ratio 295 in the execution timing table 290, to determine whether there is an entry in which the execution flag is “F”, the derivation ratio is 0%, and the derivation start date and time 292 is at or before the current time point (S53). The schedule execution unit 128 terminates the schedule execution process when there is no such entry (NO in S53) and proceeds to step S54 when there is such an entry (YES in S53).

Next, the schedule execution unit 128 refers to the execution timing table 290 to determine whether there is a model being derived (S54) and proceeds to step S56 when there is no model being derived (NO in S54) and proceeds to step S55 when there is a model being derived (YES in S54).

Specifically, the schedule execution unit 128 refers to the execution flag 294 in the execution timing table 290 and proceeds to step S56 when there is no entry with the execution flag being “T” (NO in S54) and proceeds to step S55 when there is an entry with the execution flag being “T” (YES in S54).

Next, the schedule execution unit 128 interrupts the restriction relaxing optimum operations combination generation process for a model for which the derivation is under progress, to start the derivation for the model for which the derivation start is required (S55). Specifically, for the model with the execution flag 294 in the execution timing table 290 being “T”, the restriction relaxing optimum operations combination generation process is interrupted and the execution flag 294 for such an entry is updated to be “F”.

Next, the schedule execution unit 128 starts the restriction relaxing optimum operations combination generation process for the model for which the derivation start is required (S56). Specifically, for the entry acquired in step S53, the execution flag 294 of the execution timing table 290 is updated to be “T” from “F”, and the restriction relaxing optimum operations combination generation process is started.

When the process in step S56 is terminated, the schedule execution unit 128 terminates the schedule execution process.

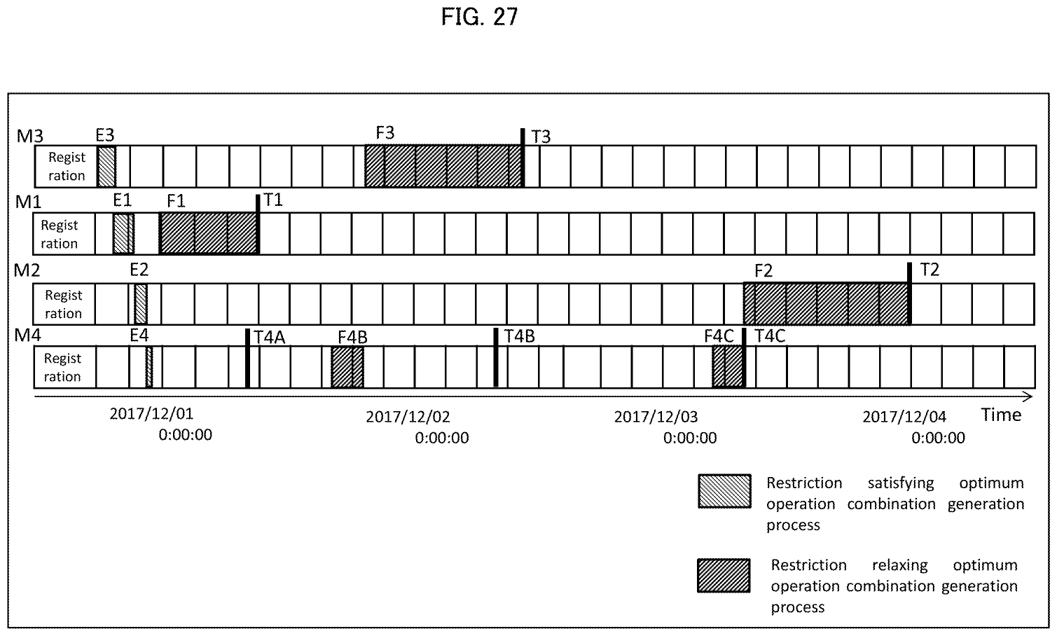

FIG. 27 is a timing chart illustrating an example of a scheduling execution process performed by the schedule execution unit.

In FIG. 27, when the models M1 to M4 with the model IDs 291 in FIG. 16 respectively being 01 to 04, the restriction-satisfying optimum operations combination-generating unit 126 in FIG. 2 executes the restriction-satisfying optimum operations combination generation processes E1 to E4 respectively on the models M1 to M4. Here, the restriction-satisfying optimum operations combination-generating unit 126 measures the time it took for each of the restriction-satisfying optimum operations combination generation processes E1 to E4, stores the time in the satisfaction derivation time 272 in the derivation time table 270 in FIG. 14, and calculates the estimated relaxation derivation time 273 for each of the models Ml to M4.

Next, for each of the models M1 to M4, the scheduling unit 127 refers to the estimated relaxation derivation time 273 and the timing of proposal 283 in FIG. 15, and sets the process timings of restriction relaxing optimum operations combination generation processes F1 to F3, F4B, and F4C such that the restriction relaxing optimum operations combination generation processes F1 to F3, F4B, and F4C end before proposal timings T1 to T3 and T4A to T4C of the models M1 to M4. When the vacant time cannot be secured for completing the restriction relaxing optimum operations combination generation processes F1 to F3, F4B, and F4C before the proposal timings T1 to T3 and T4A to T4C of the models M1 to M4, the vacant time is allocated to the models M1 to M4 in the descending order of priority. Efficient use of time can be achieved with such scheduling in which the operations combination is derived for a model with a high priority before the timing of proposal therefor, and the vacant time as a result of the derivation process is used for remaining models with higher priorities.

Next, the schedule execution unit 128 calls the restriction relaxing optimum operations combination-generating unit 129 in accordance with the process timing set by the scheduling unit 127, to cause the unit to execute the restriction relaxing optimum operations combination generation processes F1 to F3, F4B, and F4C.

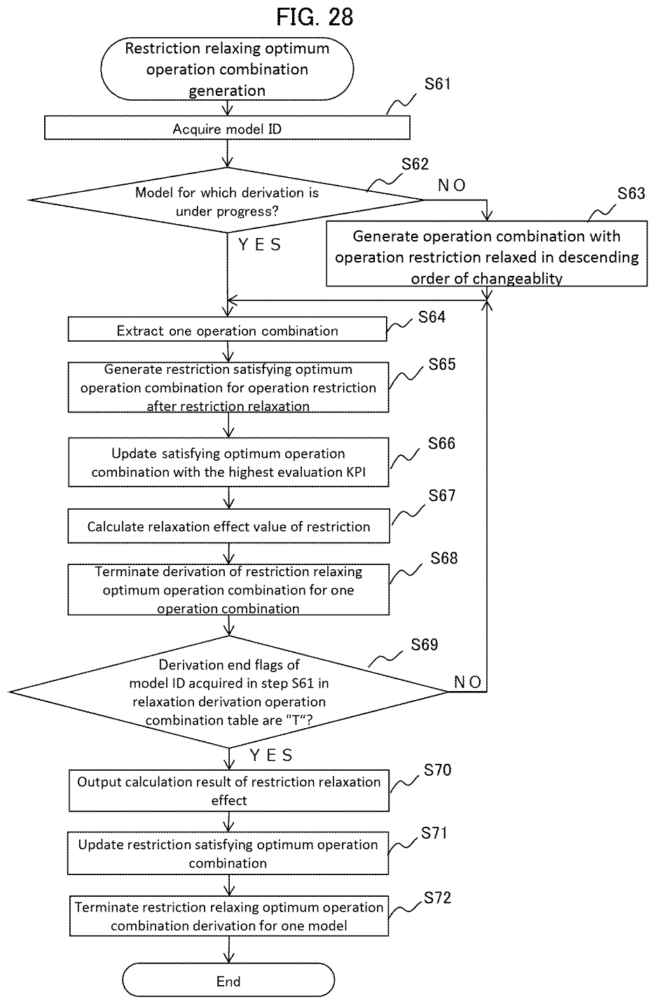

FIG. 28 is a flowchart illustrating an example of a restriction relaxing optimum operations combination generation process.

In FIG. 28, the restriction relaxing optimum operations combination-generating unit 129 in FIG. 2 is called by the schedule execution unit 128 to start the restriction relaxing optimum operations combination generation process.

The restriction relaxing optimum operations combination-generating unit 129 acquires the model ID from the schedule execution unit 128 (S61). Specifically, the restriction relaxing optimum operations combination-generating unit 129 acquires the model ID 291 of the entry with the execution flag in the execution timing table 290 in FIG. 16 being “T”.

Next, the restriction relaxing optimum operations combination-generating unit 129 determines whether the model acquired in step S61 is a model for which the derivation of the restriction relaxing optimum operations combination is under progress (S62) and proceeds to step S64 when the model is a model for which the derivation of the restriction relaxing optimum operations combination is under progress (YES in S62). Specifically, whether the relaxation derivation operations combination table 250 in FIG. 13 includes the record of the model ID acquired in step S61 is determined.

On the other hand, when the model acquired in step S61 is not a model for which the restriction relaxing optimum operations combination is under progress (NO in S62), the restriction relaxing optimum operations combination-generating unit 129 generates the operations combination with the relaxed operations restriction for the model one by one in the descending order of the changeability (S63). Specifically, when the relaxation derivation operations combination table 250 includes the operations combination with the model ID acquired in step S61, the corresponding entry is deleted, and for the operations combination with the highest evaluation KPI in the operations combinations related to the model ID acquired in step S61 in the satisfaction derivation operations combination table 230 in FIG. 12, the operations restriction is relaxed one by one in the descending order of the changeability on the basis of the restriction change table 200 in FIG. 9 registered by the operations restriction registration unit 124, to generate an operations combination, and stores the resultant entry in the relaxation derivation operations combination table 250.

In this process, the combination ID is numbered for each model ID, in the order of entry added to the relaxation derivation operations combination table 250. The relaxation effect index 262 in the relaxation derivation operations combination table 250 stores a value obtained by subtracting the highest evaluation KPI obtained by the restriction-satisfying optimum operations combination generation process performed with none of the relaxed restrictions. All values stored in the derivation end flag 263 are set to be “F”. Note that when the order is changed due to the update of the restriction change table 200 in FIG. 9, the updated order of the changeability is applied from the time point when the next entry is added to the relaxation derivation operations combination table 250. In an example of the record 189 in FIG. 7, the restriction relaxing optimum operations combination-generating unit 129 select the cycle restriction 184 associated with the procurement plan and relaxes the cycle restriction 184 by one level. Specifically, the restriction relaxing optimum operations combination-generating unit 129 relaxes the cycle restriction 184 to a frequency that is one level lower, that is, “every week” to “every month”.

When the day of the week or date restriction 185 is selected, the restriction relaxing optimum operations combination-generating unit 129 relaxes the restriction “Monday, Wednesday, and Friday” such that the updatable enabled day becomes every day of the week. When the time restriction 186 is selected, the restriction relaxing optimum operations combination-generating unit 129 relaxes the restriction “9:00 to 17:00” such that update enabled time becomes 00:00 from 24:00. When the required update time restriction 188 is selected, the restriction relaxing optimum operations combination-generating unit 129 relaxes the restriction “5 hr (the required update time can be no shorter than five hours)” is relaxed to “3 hr (the required update time can be no shorter than three hours)”. When the update logic restriction is selected, the restriction relaxing optimum operations combination-generating unit 129 adds the type of logic that can be added to relax the restriction. The level of such relaxation of the operations restriction can be selected and set by the user.

Next, the restriction relaxing optimum operations combination-generating unit 129 extracts one operations combination for the model acquired in step S61, from the operations combinations registered in the relaxation derivation operations combination table 250 (S64). Specifically, the operations combination with the smallest combination ID and with the derivation end flag 263 of “F” from the model IDs acquired in step S61 from the relaxation derivation operations combination table 250.

Next, the restriction relaxing optimum operations combination-generating unit 129 generates the restriction-satisfying optimum operations combination for the operations combination after the restriction relaxation acquired in step S64 (S65). Specifically, the satisfaction derivation operations combination table 230 deletes all the entries of the model IDs acquired in step S61 from the satisfaction derivation operations combination table 230. The restriction-satisfying optimum operations combination is generated for the operations combination in the relaxation derivation operations combination table 250 extracted in step S64. The restriction-satisfying optimum operations combination is generated by the restriction-satisfying optimum operations combination-generating unit 126.

Next, the restriction relaxing optimum operations combination-generating unit 129 stores the operations combination with the highest evaluation KPI in the restriction-satisfying optimum operations combinations obtained in step S65 (S66). Specifically, the operations combination after the restriction is relaxed acquired in step S64 in the relaxation derivation operations combination table 250 is updated with the operations combination with the highest evaluation value in the restriction-satisfying optimum operations combination obtained in step S65. In this process, the sector 233, the plan or instruction 234, the update cycle 235, the update day of the week or date 236, the update time point 237, the standard time 238, the required update time 239, the update method 240, and the evaluation KPI 241 in the satisfaction derivation operations combination table 230 are each registered in the corresponding item field in the relaxation derivation operations combination table 250.

Next, the restriction relaxing optimum operations combination-generating unit 129 calculates the relaxation effect index of the restriction for the operations combination updated in step S66 (S67). Specifically, the restriction relaxing optimum operations combination-generating unit 129 calculates the relaxation effect index 262 for each operations combination after the restriction relaxation, as a value obtained by subtracting the highest evaluation KPI obtained by the restriction-satisfying optimum operations combination generation process performed with none of the relaxed restrictions, from the evaluation KPI for the operations combination updated in step S66, and updates the relaxation effect index 262 of the relaxation derivation operations combination table 250.

Next, the restriction relaxing optimum operations combination-generating unit 129 terminates the derivation of the restriction relaxing optimum operations combination for the operations combination updated in step S66 (S68). Specifically, the restriction relaxing optimum operations combination-generating unit 129 updates the derivation end flag 263, in the relaxation derivation operations combination table 250, of the operations combination updated in step S66 to “T”. Furthermore, the restriction relaxing optimum operations combination-generating unit 129 updates the derivation ratio 295 of the entry acquired in step S61, in the execution timing table 290. The derivation ratio 295 indicates the ratio of the operations combinations for which the relaxation effect index has been calculated to the relaxed operations combinations generated in step S63.

Next, the restriction relaxing optimum operations combination-generating unit 129 determines whether the restriction-satisfying optimum operations combination has been derived for all the operations combinations corresponding to the model acquired in step S61 (S69) and returns to step S64 when not all the operations combinations have been derived yet (NO in S69). Specifically, whether the derivation end flags 263 of the operations combination of all the operations combinations corresponding to the model ID acquired in step S61, in the relaxation derivation operations combination table 250, are “T”.

On the other hand, when the restriction-satisfying optimum operations combination has been calculated for all the operations combinations corresponding to the model acquired in step S61 (YES in S69), the restriction relaxing optimum operations combination-generating unit 129 outputs the calculation result of the restriction relaxation effect (S70). Specifically, the restriction relaxing optimum operations combination-generating unit 129 extracts a predetermined number of (four for example) pieces of information related to best ones of operations combinations sorted in the descending order of the relaxation effect index calculated in step S67. The restriction relaxing optimum operations combination-generating unit 129 may determine a relaxation effect index that exceeds a threshold as a good relaxation effect index, and extract the information related to the predetermined number of (four for example) of the operations combinations with the relaxation effect index exceeding the threshold. The restriction relaxing optimum operations combination-generating unit 129 may display the information related to the extracted operations combination as well as other pieces of predetermined information on the client 104 through the output process unit 122.

Next, the restriction relaxing optimum operations combination-generating unit 129 performs updating, with the operations combination with the highest calculation result of the restriction relaxation effect index obtained in step S67 as the restriction-satisfying optimum operations combination (S71). Specifically, the restriction relaxing optimum operations combination-generating unit 129 deletes all the entries of the operations combinations, in the satisfaction derivation operations combination table 230, related to the model acquired in step S61, and registers the information about the operations combination, in the relaxation derivation operations combination table 250, with the highest calculation result for the restriction relaxation effect index in the satisfaction derivation operations combination table 230. In this process, the model ID 251, the combination ID 252, sector 253, the plan or instruction 254, the update cycle 255, the update day of the week or date 256, the update time point 257, the standard time 258, the required update time 259, the update method 260, and the evaluation KPI 261 in the relaxation derivation operations combination table 250 are each registered in the corresponding item field in the satisfaction derivation operations combination table 230.

Next, the restriction relaxing optimum operations combination-generating unit 129 terminates the restriction relaxing optimum operations combination derivation for the model acquired in step S61 (S72). Specifically, the restriction relaxing optimum operations combination-generating unit 129 updates the execution flag 294, in the execution timing table 290, corresponding to the model ID acquired in step S61, to “F”.

The restriction relaxing optimum operations combination-generating unit 129 terminates the process of this flow upon completing the process in step S72.

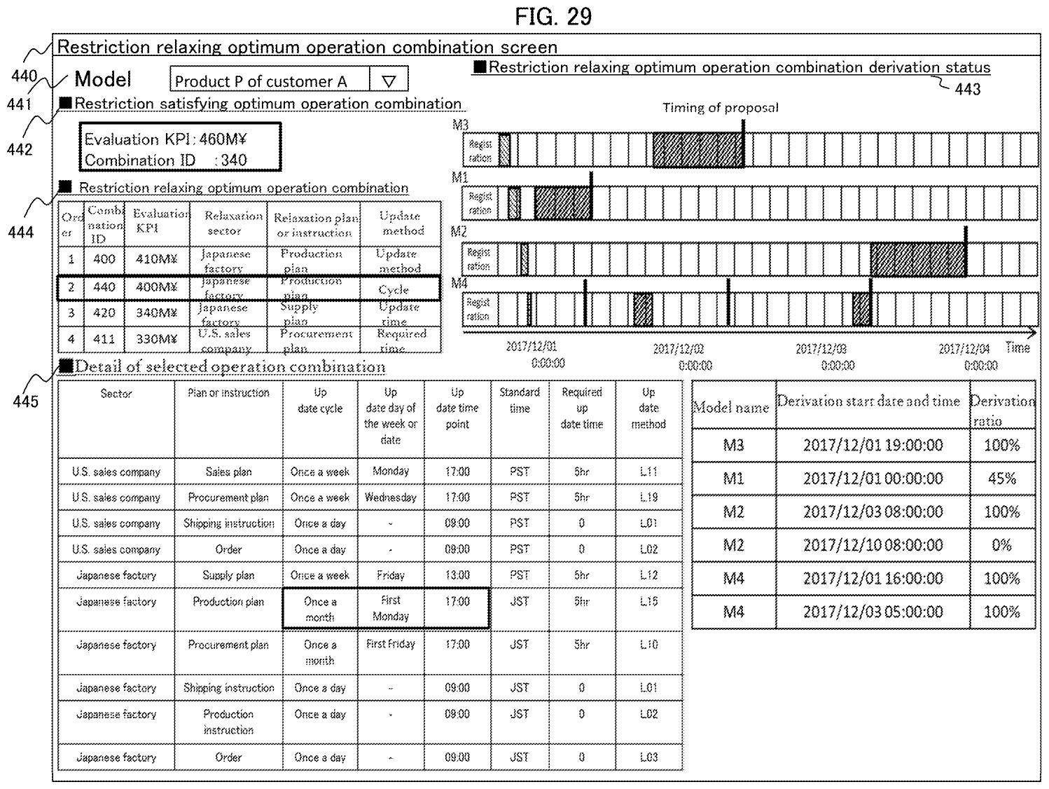

FIG. 29 is a diagram illustrating an example of a restriction relaxing optimum operations combination screen.

On the restriction relaxing optimum operations combination screen 440 in FIG. 29, a model selection field 441, a restriction-satisfying optimum operations combination display field 442, a restriction relaxing optimum operations combination derivation status display field 443, a restriction relaxing optimum operations combination display field 444, and a selected operations combination detail display field 445 are displayed. On the model selection field 441, the name of the model for which the selection input has been received is displayed. On the restriction-satisfying optimum operations combination display field 442, an evaluation KPI of an operations combination with the highest evaluation KPI calculated by the restriction-satisfying optimum operations combination process executed before the restriction relaxing optimum operations combination process, as well as the combination ID of the operations combination. On the restriction relaxing optimum operations combination derivation status display field 443, the model name, the derivation start date and time, and the derivation completion percentage are displayed determined on the basis of the restriction relaxing optimum operations combination derivation schedule as well as the model ID 291, the derivation start date and time 292, and the derivation ratio 295 in the execution timing table 290. On the restriction relaxing optimum operations combination display field 444, pieces of information related to a predetermined number of (four for example) operations combinations with the best restriction relaxation effect indexes extracted in step S70 in FIG. 28. Specifically, on the restriction relaxing optimum operations combination display field 444, the order, the combination ID, the evaluation KPI, the relaxation sector, the relaxation plan or instruction, and the relaxation item of the operations combination extracted in step S70 are displayed. On the selected operations combination detail display field 445, the detailed information about the combination selected by the user from the combinations displayed on the restriction relaxing optimum operations combination display field 444 is displayed.

When the user selects a certain operations combination from the operations combinations displayed on the restriction relaxing optimum operations combination display field 444, the restriction relaxing optimum operations combination-generating unit 129 extracts the detail information about the operations combination from the relaxation derivation operations combination table 250 in which the operations combinations after the restriction relaxation are registered, using the combination ID and the model ID of the selected operations combination as the key, and displays the information on the detail display field 445 for the operations combination through the output process unit 122.

For example, it is assumed that a combination with the combination ID of 440 is selected from the combinations displayed on the restriction relaxing optimum operations combination display field 444. Assuming that the combination with the combination ID of 440 corresponds to a combination registered in the relaxation derivation operations combination table 250 in FIG. 13, the sector 253, the plan or instruction 254, the update cycle 255, the update day of the week or date 256, the update time point 257, the standard time 258, the required update time 259, and the update method 260 in FIG. 13 are displayed on the detail display field 445. The combination ID 252 and the evaluation KPI 261 in FIG. 13 are displayed on the restriction relaxing optimum operations combination display field 444.

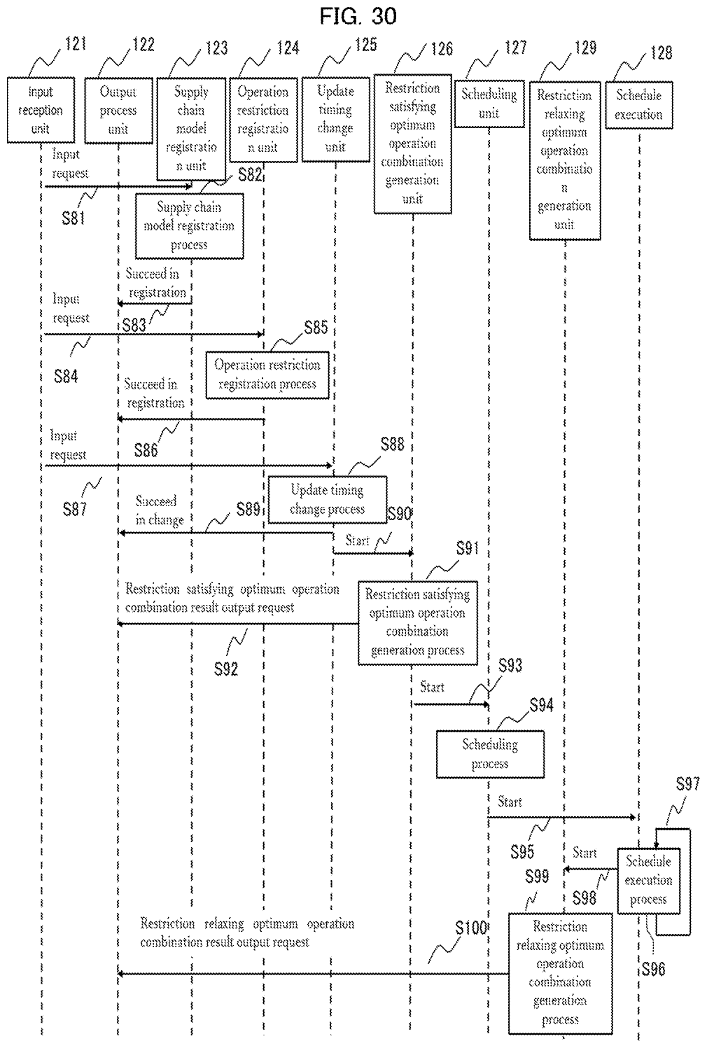

FIG. 30 is a diagram illustrating a process sequence performed by the supply chain operations process optimization device in FIG. 2.

In FIG. 30, the input reception unit 121 in FIG. 2 transmits an input request to the supply chain model registration unit 123 (S81). The supply chain model registration unit 123 executes the supply chain model registration process (S82) upon receiving the input request instruction and transmits an output request for the supply chain model registration screen to the output process unit 122 (S83).

Next, the input reception unit 121 transmits the input request to the operations restriction registration unit 124 (S84). The operations restriction registration unit 124 executes the operations restriction registration process (S85) upon receiving the input request instruction and transmits an output request to the output process unit 122 (S86).

Next, the input reception unit 121 transmits the input request to the update timing change unit 125 (S87). The update timing change unit 125 executes the update timing change process (S88) upon receiving the input request instruction and transmits the output request for the update timing change screen to the output process unit 122 (S89).

After the execution of the update timing change process is completed, the update timing change unit 125 issues an instruction for start the restriction-satisfying optimum operations combination generation process (S90). The restriction-satisfying optimum operations combination-generating unit 126 executes the restriction-satisfying optimum operations combination generation process (S91) and transmits a restriction-satisfying optimum operations combination result output request to the output process unit 122 (S92).

After the execution of the restriction-satisfying optimum operations combination generation process is completed, the restriction-satisfying optimum operations combination-generating unit 126 issues an instruction to start a scheduling process (S93), and the scheduling unit 127 executes the scheduling process (S94).

After the execution of the scheduling process is completed, the scheduling unit 127 issues an instruction to start the schedule execution process (S95), and the schedule execution unit 128 executes the schedule execution process (S96). Meanwhile, the schedule execution unit 128 monitors the execution timing table 290 at a certain short interval and terminates the monitoring when execution of all the entries of the execution timing table 290 is completed (S97). When the next model for which the derivation is required is found during the monitoring of the execution timing table, the schedule execution unit 128 instructs the restriction relaxing optimum operations combination-generating unit 129 to start the restriction relaxing optimum operations combination generation process (S98).

Next, the restriction relaxing optimum operations combination-generating unit 129 executes the restriction relaxing optimum operations combination generation process (S99) and transmits the restriction relaxing optimum operations combination result output request to the output process unit 122 (S100).

With the first embodiment as described above, the supply chain operations process optimization device 101 can generate a supply chain operations process draft with a higher evaluation KPI satisfying operations restrictions for one or more supply chain models and can also propose an operations combination for which the effect of relaxing the restriction is high before the timing of proposal. In particular, the supply chain operations process optimization device 101 generates operations combinations for the supply chain while taking into account restriction on the timing and the method for updating each plan or instruction such as a sales plan and uses evaluation KPIs thereof to identify an operations combination with an excellent evaluation KPI, and thus can propose more appropriate supply chain operations process draft to the user. The supply chain operations process optimization device 101 generates the operations combinations with a high restriction relaxation effect, and thus the user can easily recognize which one of the restrictions can be relaxed to achieve a larger evaluation index improvement. With a plurality of supply chains provided with priorities and scheduled, the operations combinations with the highest possible effect of relaxation can be generated by a timing required by the user.

In the first embodiment described above, the method for scheduling the restriction relaxing optimum operations combination generation process is described, but not only the restriction relaxing optimum operations combination generation process but also the restriction-satisfying optimum operations combination generation process can be scheduled.

A second embodiment is described below in detail. In the following description, a process different from those in the first embodiment will be mainly described. In the second embodiment, a time required for deriving the restriction-satisfying optimum operations combination is estimated on the basis of resource information about the CPU 111 in FIG. 2 and the like, from the configuration of the supply chain model registered.

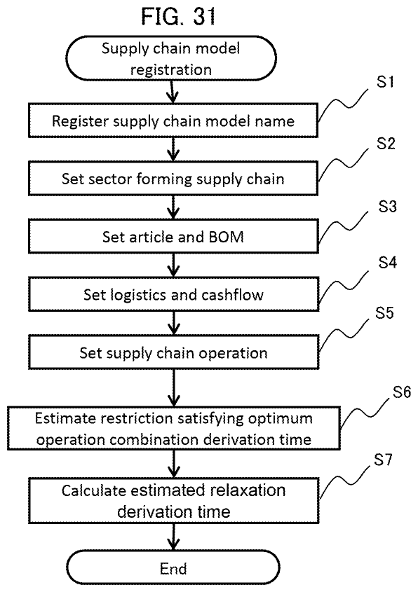

FIG. 31 is a flowchart illustrating an example of a supply chain model registration process according to the second embodiment.

In FIG. 31 illustrating the second embodiment, the supply chain model registration unit 123 sets the supply chain operation (S5), and then estimates the restriction-satisfying optimum operations combination derivation time (S6). In this process, the supply chain model registration unit 123 acquires information about the number of companies and the number of articles in the inter-sector transaction condition parameter table 150 and the production condition parameter table 160 updated due to the registration button 406 on the supply chain model registration screen 400 being pressed.

Specifically, the supply chain model registration unit 123 acquires the number of companies on the basis of the To sector 152 and the From sector 153 corresponding to the model ID 151 updated in the inter-sector transaction condition parameter table 150 and acquired the number of articles from the article 163 in the production condition parameter table 160. The derivation time for the restriction-satisfying optimum operations combination is estimated by multiplying an evaluation KPI calculation time for 1 company-1 article model measured on the basis of the resource information about the CPU 111 and the like by the number of companies acquired and by the number of articles acquired. The supply chain model registration unit 123 registers the estimated derivation time for the restriction-satisfying optimum operations combination together with the model ID, in the model ID 271 and the satisfaction derivation time 272 in the derivation time table 270 in FIG. 14.

Next, the supply chain model registration unit 123 calculates the estimated relaxation derivation time (S7). Specifically, the supply chain model registration unit 123 uses the satisfaction derivation time acquired in step S6 to calculate the estimated relaxation derivation time. The calculation is implemented by multiplying the satisfaction derivation time by the number of restrictions by the number of plans or instructions, such that the resultant value is obtained as the estimated relaxation derivation time. Furthermore, the restriction-satisfying optimum operations combination-generating unit 126 stores the calculated estimated relaxation derivation time in the estimated relaxation derivation time 273 in the derivation time table 270.

When the process in step S7 is completed, the supply chain model registration unit 123 terminates the supply chain model registration process.

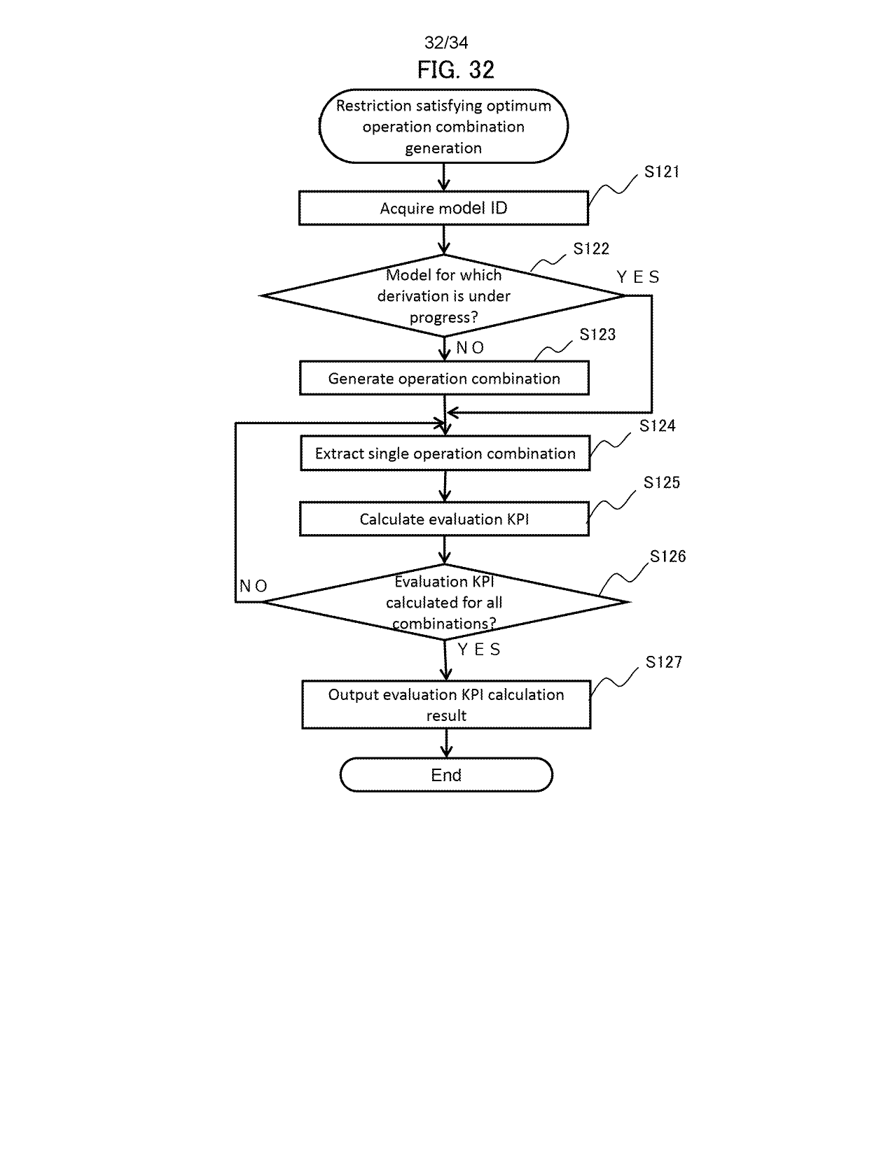

FIG. 32 is a flowchart illustrating an example of a restriction-satisfying optimum operations combination generation process according to the second embodiment.

In FIG. 32 illustrating the second embodiment, the restriction-satisfying optimum operations combination-generating unit 126 in FIG. 2 also performs scheduling on the restriction-satisfying optimum operations combination generation process, and thus does not measure the satisfaction derivation time or estimate the relaxation derivation time. On the other hand, the restriction-satisfying optimum operations combination generation process may be interrupted upon being the scheduling target.

The restriction-satisfying optimum operations combination-generating unit 126 acquires the model ID from the schedule execution unit 128 (S121). Specifically, the restriction-satisfying optimum operations combination-generating unit 126 acquires the model ID 291 corresponding to an entry with the execution flag in the execution timing table 290 being “T”.

Next, the restriction-satisfying optimum operations combination-generating unit 126 determines whether the model acquired in step S121 is a model for which the derivation of the restriction-satisfying optimum operations combination is under progress (S122) and proceeds to step S124 when it is the model for which the derivation of the restriction-satisfying optimum operations combination is under progress (NO in S122). Specifically, whether the satisfaction derivation operations combination table 230 in FIG. 12 includes a record corresponding to the model ID acquired in step S121.

On the other hand, when the model acquired in step S121 is not a model for which the derivation of the restriction-satisfying optimum operations combination is under progress (NO in S122), the restriction-satisfying optimum operations combination-generating unit 126 generates the operations combination in the satisfaction derivation operations combination table 230 (S123). Specifically, the restriction-satisfying optimum operations combination-generating unit 126 refers to the plan or instruction operation parameter table 170 stored in the supply chain model storage unit 130 as well as the update timing restriction table 180 and the update method restriction table 190 stored in the operations restriction storage unit 131 to generate the satisfaction derivation operations combination table 230 storing operations combinations for a supply chain that satisfy the predetermined restrictions registered in these restriction tables and that do not overlap with each other. The restriction-satisfying optimum operations combination-generating unit 126 numbers the combination ID for each operations combination and stores the number in the corresponding item filed in the satisfaction derivation operations combination table 230.

Next, the restriction-satisfying optimum operations combination-generating unit 126 extracts a single operations combination from the operations combinations registered in the satisfaction derivation operations combination table 230 (S124). Specifically, the restriction-satisfying optimum operations combination-generating unit 126 extracts a single operations combination for which the evaluation KPI has not been calculated yet, in the operations combinations, in the satisfaction derivation operations combination table 230, corresponding to the model ID acquired in step S121.

Next, the restriction-satisfying optimum operations combination-generating unit 126 calculates the evaluation KPI for the extracted operations combination (S125). Then, whether the evaluation KPI has been calculated for all the operations combinations registered in the satisfaction derivation operations combination table 230 (S126), and the process returns to step S124 when there is an operations combination for which the evaluation KPI has not been calculated (NO in S126).

On the other hand, when the evaluation KPI has been calculated for all the operations combination (YES in S124), the restriction-satisfying optimum operations combination-generating unit 126 outputs the evaluation KPI calculation result (S127).

When the process in step S127 is completed, the restriction-satisfying optimum operations combination-generating unit 126 terminates the restriction-satisfying optimum operations combination generation process.

Next, in step S42 in the scheduling process in FIG. 25, the scheduling unit 127 obtains the sum of the satisfaction derivation time and the estimated relaxation derivation time for the model acquired in step S41 as the remaining derivation time, unlike in the first embodiment. Specifically, in a process of acquiring the model ID and the timing of proposal in the ascending order of the schedule number in the scheduling table 280 in step S41, the scheduling unit 127 obtains a result of adding the estimated relaxation derivation time to the satisfaction derivation time as the remaining derivation time when the restriction relaxing optimum operations combination is generated for the first time for each model.

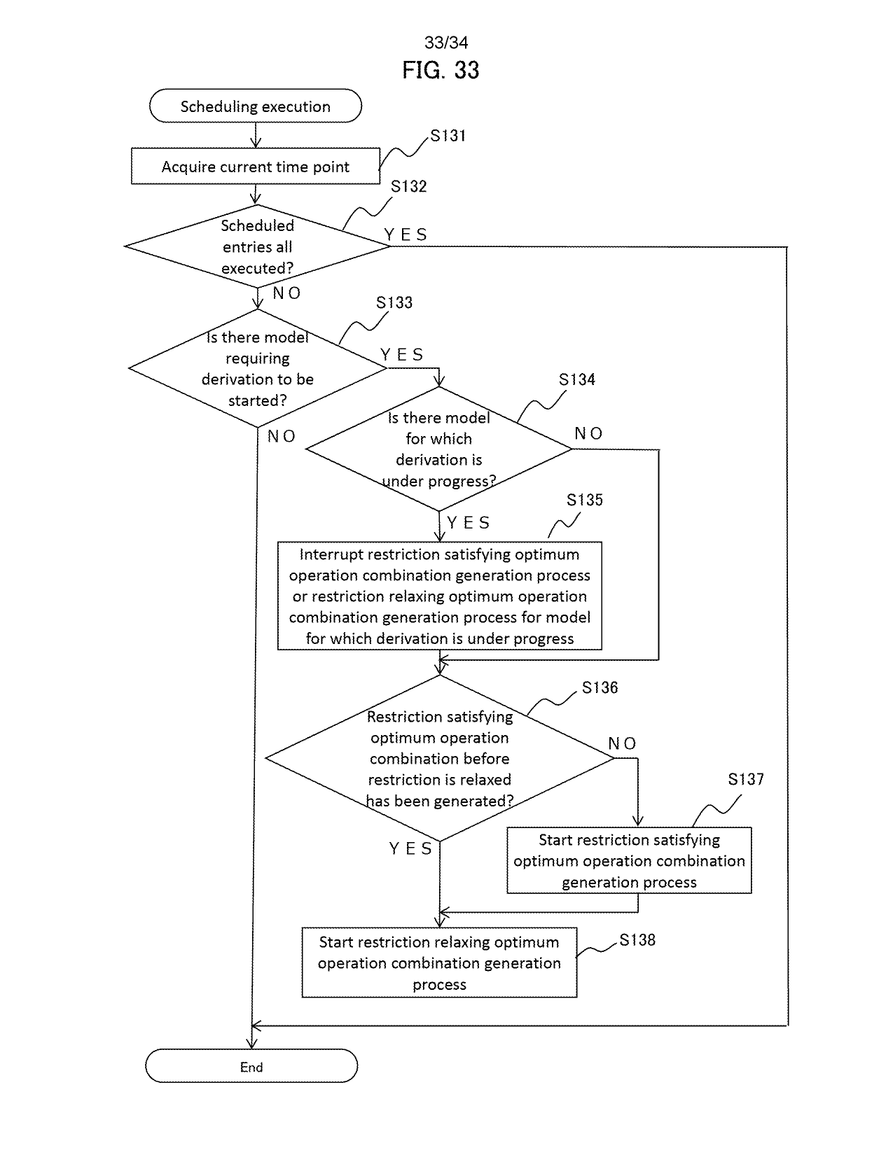

FIG. 33 is a flowchart illustrating an example of a scheduling execution process according to the second embodiment.

In FIG. 33 illustrating the second embodiment, the restriction-satisfying optimum operations combination generation process is also a target of the scheduling, and thus the restriction-satisfying optimum operations combination-generating unit 126 starts the process by being called by the schedule execution unit 128.

The schedule execution unit 128 acquires the current time point (S131). Next, the schedule execution unit 128 refers to the execution timing table 290 and determines whether the scheduled entries have all been executed (S132). When there is no model for which the scheduled entry has not been executed yet (YES in S132), the schedule execution unit 128 terminates the schedule execution process. On the other hand, when there is a model for which the scheduled entry has not been executed yet (NO in S132), the schedule execution unit 128 proceeds to step S133.

Next, the schedule execution unit 128 determines whether there is a next model requiring the derivation to be started (S133) and terminates the schedule execution process when there is not model requiring the derivation to be started (NO in S133). On the other hand, when there is a model requiring the derivation to be started (YES in S133), the process proceeds to step S134.

Next, the schedule execution unit 128 refers to the execution timing table 290 to determine whether there is a model for which the derivation is under progress (S134) and proceeds to step S136 when there is not model for which the derivation is under progress (NO in S134). Specifically, the schedule execution unit 128 refers to the execution flag 294 in the execution timing table 290 and proceeds to step S136 when there is no entry with the execution flag being “T” (NO in step S134).

On the other hand, when there is a model for which the derivation is under progress (YES in S134), the schedule execution unit 128 proceeds to step S135. Specifically, when there is an entry with the execution flag being “T” (YES in S134), the schedule execution unit 128 interrupts the restriction-satisfying optimum operations combination generation process or the restriction relaxing optimum operations combination generation process for the model for which the derivation is under progress, to start the derivation for the model requiring the derivation to be started (S135).

Next, the schedule execution unit 128 determines whether the restriction-satisfying optimum operations combination before the restriction is relaxed has been generated (S136) and proceeds to step S138 when the restriction-satisfying optimum operations combination before the restriction is relaxed has been generated (YES in S136). On the other hand, when the restriction-satisfying optimum operations combination before the restriction is relaxed has not been generated yet (NO in S136), the schedule execution unit 128 starts the restriction-satisfying optimum operations combination generation process (S137). Specifically, the schedule execution unit 128 starts the restriction-satisfying optimum operations combination generation process is started for the model corresponding to the entry acquired in step S133.

Next, the schedule execution unit 128 starts the restriction relaxing optimum operations combination generation process for the model for which the start of the derivation is required (S138).

When the process in step S138 is completed, the schedule execution unit 128 terminates the scheduling execution process.

With the second embodiment described above, the scheduling can be performed not only on the restriction relaxing optimum operations combination generation process but can also be performed on the restriction-satisfying optimum operations combination generation process. Thus, in a vacant time of the restriction relaxing optimum operations combination generation process of one supply chain model in a plurality of supply chain models, the restriction-satisfying optimum operations combination generation process can be performed for another supply chain model, and this can improve the effect of relaxation on the operations combination for the supply chain that can be proposed before the time at which the combination is required.

The function blocks of the supply chain operations process optimization device 101 are obtained by categorizing the functions of the supply chain operations process optimization device 101 implemented in the present embodiment on the basis of main process contents, and thus the present invention is not limited by how the functions are classified or the names of the functions. Furthermore, the configurations of the supply chain operations process optimization device 101 can be categorized into even more configuration elements, in accordance with the process contents. A single configuration element can further be classified to perform even more processes.

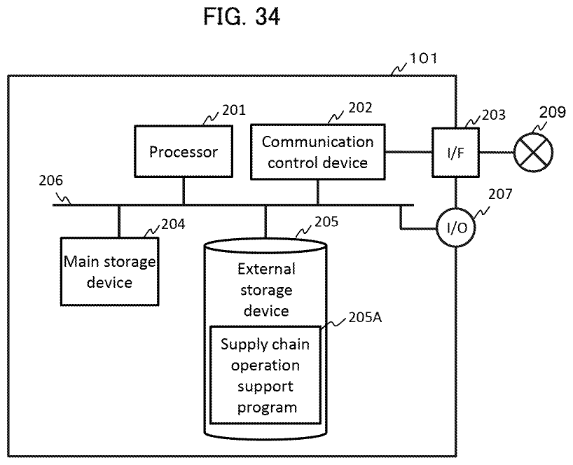

FIG. 34 is a block diagram illustrating a hardware configuration example of the supply chain operations process optimization device illustrated in FIG. 1.

In FIG. 34, the supply chain operations process optimization device 101 includes a processor 201, a communication control device 202, a communication interface 203, a main storage device 204, an external storage device 205, and an input/output interface 207. The processor 201, the communication control device 202, the communication interface 203, the main storage device 204, the external storage device 205, and the input/output interface 207 are coupled to each other via an internal bus 206. The main storage device 204 and the external storage device 205 can be accessed by the processor 201.

The processor 201 is hardware that performs operation control of the entire supply chain operations process optimization device 101. The main storage device 204 can include, for example, a semiconductor memory such as an SRAM or a DRAM. The main storage device 204 may be provided with a work area in which the processor 201 stores a program that the processor is executing or in which the processor 201 executes a program.

The external storage device 205 is a storage device having a large storage capacity, and a hard disk apparatus or an SSD (Solid State Drive), for example. The external storage device 205 can hold executable files of various types of programs and data used for execution of a program. The external storage device 205 can store a supply chain operation support program 205A. The supply chain operation support program 205A may be software that can be installed in a supply chain operations process optimization device 22A or may be embedded as firmware in the supply chain operations process optimization device 101.

The communication control device 202 is hardware having a function of controlling communications with the outside. The communication control device 202 is coupled to a network 209 via the communication interface 203. The network 209 may be a WAN (Wide Area Network) such as the Internet, may be a wireless or wired LAN (Local Area Network), or may be a combination of a WAN and a LAN. The input/output interface 207 is hardware having a data input/output function.

The processor 201 reads the supply chain operation support program 205A to the main storage device 204 and executes the supply chain operation support program 205A, thereby, on the basis of the time required for deriving the operations combination with the relaxed operations restriction on the supply chain, determining derivation start timing of an operations combination with the relaxed operations restriction and proposing an operations combination with a higher evaluation KPI by a set timing.

The supply chain operation support program 205A can implement the functions of the input reception unit 121, the output process unit 122, the supply chain model registration unit 123, the operations restriction registration unit 124, the update timing change unit 125, the restriction-satisfying optimum operations combination-generating unit 126, the scheduling unit 127, the schedule execution unit 128, and the restriction relaxing optimum operations combination-generating unit 129 illustrated in FIG. 2.

Execution of the supply chain operation support program 205A may be shared by a plurality of processors or computers. Alternatively, the processor 201 may instruct a cloud computer or the like through the network 209 to execute part or the whole of the supply chain operation support program 205A and receive a result of execution.

The present invention is not limited to the above-described embodiments and include various modifications. For example, the above-described embodiments are described in detail to illustrate the present invention in an understandable way, and not all the configurations described above are required. In addition, part of the configuration of an embodiment can be replaced with a configuration of another embodiment, and the configuration of an embodiment may include a configuration of another embodiment. Furthermore, a part of the configuration can include another configuration or can be deleted or substituted.

What is claimed is:

1. A supply chain operations process optimization device comprising:
a first operations combination-generating unit configured to derive an operations combination with a relaxed operations restriction on a supply chain; and
a scheduling unit configured to determine an operations combination derivation-starting timing with the relaxed operations restriction on the basis of a time required for deriving the operations combination with the relaxed operations restriction.

2. The supply chain operations process optimization device according to claim 1, wherein the scheduling unit is configured to determine the operations combination derivation-starting timing with the relaxed operations restriction such that the operations combination with the relaxed operations restriction should be derived before a timing of proposal.

3. The supply chain operations process optimization device according to claim 2, wherein the scheduling unit is configured to determine the operations combination derivation-starting timing with the relaxed operations restriction such that an operations combination having a relaxation effect index exceeding a predetermined threshold in the operations combination with the relaxed operations restriction should be identified before the timing of proposal.

4. The supply chain operations process optimization device according to claim 1, wherein the scheduling unit is configured to determine derivation start date and time and derivation end date and time for the operations combination with the relaxed operations restriction on the basis of a time required for deriving the operations combination with the relaxed operations restriction and a timing of proposal of the operations combination with the relaxed operations restriction.

5. The supply chain operations process optimization device according to claim 1, wherein the first operations combination-generating unit is configured to generate an operations combination with a relaxed update timing and a relaxed method for each plan or instruction from each of sectors constituting the supply chain.

6. The supply chain operations process optimization device according to claim 1, further comprising a supply chain model registration unit configured to register information related to flows of operations, products, and cash in the supply chain as a supply chain model, together with identification information about the supply chain model.

7. The supply chain operations process optimization device according to claim 1, further comprising an operations restriction registration unit configured to register information related to restrictions on an update timing and a method for each plan or instruction from each of sectors constituting the supply chain as the operations restriction.

8. The supply chain operations process optimization device according to claim 1, further comprising an update timing change unit configured to register a priority for relaxing the operations restriction for the supply chain and a timing of proposal of the operations combination with the operations restriction that has been relaxed.

9. The supply chain operations process optimization device according to claim 1, further comprising a schedule execution unit configured to start, on the basis of the derivation start timing determined by the scheduling unit, derivation of the operations combination with the relaxed operations restriction.

10. The supply chain operations process optimization device according to claim 1, further comprising a second operations combination-generating unit configured to derive an operations combination that satisfies an operations restriction on the supply chain, wherein
the first operations combination-generating unit is configured to derive all operations combinations obtained by performing relaxation one by one on update timings and methods for each plan or instruction from each of sectors constituting the supply chain.

11. The supply chain operations process optimization device according to claim 10, wherein the second operations combination-generating unit is configured to estimate a time required for deriving the operations combination with the relaxed operations restriction on the basis of a time required for deriving an operations combination satisfying the operations restriction.

12. The supply chain operations process optimization device according to claim 11, wherein the second operations combination-generating unit is configured to acquire the time required for deriving the operations combination satisfying the operations restriction on the basis of a time required for calculating evaluation KPIs of all operations combinations satisfying the operations combination for the update timing and the method for each plan or instruction.

13. The supply chain operations process optimization device according to claim 11, wherein the scheduling unit is configured to determine the operations combination derivation-starting timing with the relaxed operations restriction on the basis of an estimated value of a time required for the operations combination with the relaxed operations restriction.

14. The supply chain operations process optimization device according to claim 10, wherein
a time required for deriving an operations combination satisfying the operations restriction is estimated on the basis of a number of companies in each of sectors constituting the supply chain and a number of articles traded between the sectors, and
a time required for deriving the operations combination with the relaxed operations restriction is estimated on the basis of an estimation value of the time required for deriving the operations combination satisfying the operations restriction.

15. The supply chain operations process optimization device according to claim 14, wherein the scheduling unit is configured to determine the operations combination satisfying the operations restriction and the operations combination derivation-starting timing with the relaxed operations restriction on the basis of an estimation value of a time required for deriving the operations combination satisfying the operations restriction and an estimation value of a time required for deriving the operations combination with the relaxed operations restriction.

16. The supply chain operations process optimization device according to claim 2, wherein
the supply chain comprising:
a first supply chain; and
a second supply chain with a lower priority than the first supply chain, wherein
the scheduling unit is configured to
determine the derivation start timing such that the operations combination with the relaxed operations restriction on the supply chain for the first supply chain should be derived before a timing of proposal, and
execute a process of deriving the operations combination with the relaxed operations restriction on the supply chain for the second supply chain in a vacant time in the process of deriving the operations combination with the relaxed operations restriction on the supply chain for the first supply chain.

17. The supply chain operations process optimization device according to claim 2, wherein
the supply chain comprises:
a first supply chain; and
a second supply chain with a lower priority than the first supply chain, wherein
the scheduling unit is configured to
determine the derivation start timing such that the operations combination with the relaxed operations restriction on the supply chain for the first supply chain should be derived before a timing of proposal, and
interrupt, when the operations combination derivation-starting timing with the relaxed operations restriction on the first supply chain arrives during the process of deriving the operations combination with the relaxed operations restriction on the second supply chain, the process of deriving the operations combination with the relaxed operations restriction on the second supply chain, and start the process of deriving the operations combination with the relaxed operations restriction on the first supply chain.

18. A method for supporting an operation of a supply chain including a processor, wherein
the processor determines an operations combination derivation-starting timing with a relaxed operations restriction on the basis of a time required for deriving an operations combination with the relaxed operations restriction on the supply chain.
